(19) United States
(12) Patent Application Publication
(10) Pub. No.: US 2002/0065073 A1
(43) Pub. Date: May 30, 2002

(54) Extended-cell communication network and transmission apparatus

(76) Inventors: Morihito Natani, Kawasaki (JP); Yasuo Suzuki, Kawasaki (JP); Atsushi Suzuki, Kawasaki (JP); Junichi Kawano, Kawasaki (JP)

Correspondence Address: ROSENMAN & COLIN LLP, 575 MADISON AVENUE, NEW YORK, NY, 10022-2585, US

(21) Appl. No.: 09/901,198

(22) Filed: Jul. 9, 2001

(30) Foreign Application Priority Data
Nov. 30, 2000 (JP) 2000-364098

(51) Int. Cl. H04Q 7/20

(52) U.S. Cl. 455/422; 455/525; 455/524

(57) ABSTRACT

Disclosed is a transmission apparatus so adapted that extended-cells of variable-length cell can be handled. To accomplish this, the apparatus includes a receiver for receiving a frame signal from a transmission path; a demultiplexing/demapping unit for demultiplexing and demapping extended-cells from a payload of the frame signal received from the transmission path; a cell synchronizer for executing cell synchronization processing to identify a boundary of an extended-cell; a controller for subjecting an extended-cell to switching and other control; a multiplexing/mapping unit for multiplexing and mapping an extended-cell, which is output from the controller, onto a payload of a frame signal; and a transmitter for transmitting this frame signal to a transmission path.

### BACKGROUND OF THE INVENTION

This invention relates to an extended-cell communication network and transmission apparatus. More particularly, the invention relates to a transmission apparatus (ATM apparatus, SDH transmission apparatus, ADM apparatus, etc.), which has an interface function such as a SONET/SDH or photonic (WDM, OADM) interface function, and which is capable of dealing with extended-cells, and to an extended-cell communication network.

IP-Packet Transmission Utilizing ATM

In a Conventional ATM-cell transmission network, only the transmission of ATM cells having a fixed cell length (53 bytes) is supported. In regard to fixed-length ATM cells, various techniques concerning an apparatus for placing these ATM cells in a SONET/SDH frame, methods of transmitting these cells and methods of constructing the related networks have been proposed. When an attempt is made to transmit a packet/frame, such as an IP packet, having a packet length greater than 53 bytes in such a fixed-length ATM cell transmission network using ATM cells for the transmission, it is necessary to transmit the packet upon dividing it up into the payloads of a plurality of ATM cells. FIG. 31 is a diagram useful in describing an IP-packet transmission scheme that utilizes ATM. As shown in FIG. 31, an IP packet PKT has a header PH and transmit data DT. The header PH includes various information, beginning with a source address SA and destination address DA. The IP packet PKT is split into a number of ATM cells CL₁ to CLₙ, and a cell header HD is attached to the beginning of each cell. Channel identifiers (VPI/VCI) contained in the headers of each of the ATM cells CL₁ to CLₙ have the same values. Thus, in order to transport such an IP packet utilizing ATM, the IP packet is divided up into 48-byte units (cell units), an ATM header is added onto each cell and the cells are then transmitted.

An ATM cell in such an IP-packet transmission scheme utilizing ATM requires a 5-byte header. In other words, the header occupies 10% of the total. This means that of the headers of the ATM cells carrying the same packet data, the headers from the second cell onward are needless. That is, when an IP packet or the like is transmitted, waste of approximately 10% is produced by mapping the data into the ATM cells. Further, since data having a length greater than the frame length is transmitted upon being divided, a mechanism for reconstructing the data at a receiver in order to restore the data to the original packet is required. Hence there is need of a variable-length ATM cell transmission scheme that is capable of enlarging cell length.

POS (Packet Over SONET or SDH)

In order to transmit ATM cells or packets such as IP packets by SONET or SDH, packets are transmitted upon being mapped onto the payload of a SONET or SDH frame. FIG. 32 is a diagram useful in describing frame format in ATM cell transmission utilizing POS. This illustrates a case where ATM cells CL are transmitted upon being mapped onto an STS-3 (OC-3) payload PL. The STS-3 (OC-3) frame is composed of 9×270 bytes, in which the initial 9×9 bytes constitute section overhead SOH and the remaining bytes constitute path overhead POH and payload PL. The ATM cells are mapped onto the payload PL.

NNI (Network Node Interface) Multiplexing Method in SDH

In accordance with an SDH multiplexing method, multiplexing is performed by a method which includes adding overhead information onto several signals on the side of a lower order group, placing the signals in containers, gathering several containers together and placing them in a larger container. FIG. 33 is a diagram useful in describing SDH multiplexing. A container obtained by adding POH (path overhead) onto a container is referred to as a “virtual container”. Virtual containers are expressed by VC-11, VC-12, etc. Furthermore, a virtual container whose position is indicated by a pointer is referred to as a “tributary unit” (TU). If four 1.5-Mbps TU-11s are gathered together, the result is a 6-Mbps TUG-2 (Tributary Unit Group 2). There are also instances where a TUG-2 is composed of three 2-Mbps TU-12s or one 6-Mbps TU-2.

If seven TUG-2s are collected and a POH is added on, the result is a VC-3, and if 21 TUG-2s are collected and a POH is added on, then the result is a VC-4. If two speed-adjustment fixed stuff bytes SB1, SB2 of one column each are inserted into an 85-column VC-3, three of these are gathered together and section overhead SOH is added onto the beginning thereof, an STM-1 (Synchronous Transport Module Level 1) frame can be produced. Further, if section overhead SOH is added onto the beginning of a 260-column VC-4, an STM-1 can be produced.

Conventional SDH Apparatus

FIG. 34 illustrates a conventional SDH transmission apparatus. The apparatus includes an optoelectronic transducer 1 for converting between optical and electrical signals; SOH terminating equipment 2 for inserting/separating STM-1 SOH; POH terminating equipment 3 for inserting/separating VC-4 POH and for executing VC-4 stuff processing; a multiplexer (MUX) 4 for multiplexing three VC-3s and converting them to a VC-4; a demultiplexer (DMUX) 5 for demultiplexing a VC-4 and converting it to three VC-3s; a TUG-2→VC-3 converter 6 for converting a TUG-2 to a VC-3; a VC-3→TUG-2 converter 7 for converting a VC-3 to a TUG-2; TU terminating equipment 8 for terminating TUG-2 data; a cross-connect unit 9 for cross-connecting low-speed data in VC-11, VC-12 or VC-2 units; and a low-speed interface 10 for interfacing data on a low-speed side.

In the conventional SDH apparatus, as illustrated in FIG. 34, data from the low-speed side is assembled into a TUG-2 by the TU terminating equipment 8, POH is added on by the POH terminating equipment 3, SOH is added on by the SOH terminating equipment 2 and the resulting data is transmitted to the high-speed side. When synchronous operation occurs, processing is executed by converting stuff processing of VC-4 to TU (Tributary Unit) stuff processing.

FIG. 35 is a diagram useful in describing conversion from VC-4 stuff processing to TU stuff processing. In STM-1 on the side of the transmission line, an H3 byte comprising three bytes is inserted as a negative-stuff byte after H1, H2 bytes (three bytes each) in the pointer PT of VC-4 section overhead SOH. At the time of synchronous operation, phase is discriminated by the pointer value of the H1, H2 bytes in the POH terminating equipment 3. When it becomes necessary to perform positive stuffing, which delays phase, 3-byte data serving as dummy data is inserted into the H3 byte. When it becomes necessary to perform negative stuffing, which advances phase, the succeeding actual data is inserted into this portion. When stuffing is carried out, the ensuing data is advanced or delayed three bytes at a time by this processing. In STM-1 on the apparatus side, TUG-2 is provided with a V3 byte as a TU pointer 3 for negative stuffing in correspondence with the H3 byte in STM-1 on the side of the transmission line. With regard to the V3 byte, 1-byte dummy data is inserted when positive stuffing has been performed in STM-1 on the side of the transmission line, and the succeeding actual data is inserted in this portion when negative stuffing has been performed. The V3 byte is allocated one byte at a time when TUG-2 is separated into lower layers. In FIG. 35, V1 and V2 are TU pointers 1 and 2, respectively, and V4 is a reserved byte (unused).

Variable-Length ATM

Variable-length ATM is ATM with a payload of variable length; length is not limited to 48 bytes. FIG. 36 is a diagram useful in describing variable-length ATM. In the ATM layer, a length of n (8≧n≧6) is adopted as the minimum transport unit, and a variable-length cell CL is constructed by an n-octet header HD and an ATM cell payload PLD whose length is a whole-number (m≧1) multiple of the minimum transport unit. Information generated from the higher layer is adjusted and stored in the payload PLD so as to obtain a length that is a whole-number multiple of the minimum transport unit, and data RCC indicating the length of the variable-length cell is set in the header HD. The adjustment is performed in the higher order ATM adaptation layer by adding on invalid data in such a manner that a SAR protocol data unit (SAR-PDU), which includes a header and a trailer, will become a whole-number multiple of n octets, and it is so arranged that a number of octets (the hatched portion), which is the result of dividing the number of octets of the valid information by 44, will be set in the trailer. The reason for the figure of “44” is that the SAR-PDU payload length is 44 bytes when a payload of 48 bytes of the conventional fixed-length cell internally possesses the SAR structure (=cell disassembly/assembly mechanism) of the higher order layer AAL. When a fixed-length cell and a variable-length cell are mixed, this can be identified by determining whether the header length is n octets or five octets.

FIG. 37 is a schematic block diagram of a variable-length processing apparatus. The apparatus includes an input buffer 21, a header analyzer 22, a switch 23 and a controller 24. If user information UD of an arbitrary length L1 is generated in the higher order layer, as shown in FIG. 36, the information is delivered to the ATM adaptation layer (=AAL) as one block of information irrespective of the information length, a corresponding header and trailer are added in this layer and a data unit the length of which is indicated by L2 is created. The data unit having this length L2 is created as the variable-length cell CL indicated by L3 in the ATM layer. In the variable-length cell CL, the header HD is composed of n octets, which is the minimum transport unit, and the ATM cell payload PLD is n×m octets. That is, if the data unit of the ATM adaptation layer (AAL) is delimited so as to become m (m≧1) times n octets and data that does not satisfy the n-octet requirement is subsequently generated, the invalid octet (the hatched portion) is added on to make the length n octets and the ATM cell payload PLD becomes n×m octets in length. The overall length of the variable-length ATM cell CL is n×(m+1) octets, and the minimum cell length is n×2 octets (inclusive of the header). The maximum cell length is n×(M+1), where M represents the maximum value of m.

As shown in FIG. 38, a cell-length indication (Row of Cell Count: RCC) is provided, along with information such as VPI, VCI identical with that of the header of a fixed-length ATM cell, in the header HD of the variable-length ATM cell CL, a multiple (m+1) of the above-mentioned minimum transport unit or m (=a multiple of the minimum transport unit of payload length) is set in this portion and switching control or checking is performed using the information representing the cell-length indication (RCC).

When a variable-length ATM cell CL enters the variable-length ATM cell processing apparatus from an input line, the input buffer 21 stores this cell temporarily and the header analyzer 22 extracts the VPI, VCI and cell-length indication RCC from the header HD and supplies these to the controller 24. If it is possible to identify that the input extended ATM cell is a conventional fixed-length cell, then the cell can be handled as a conventional fixed-length cell.

The controller 24 decides the output line based upon VPI, VCI, sets a path connecting the input and output lines of the cell in the switch 23 and holds the path for a time long enough for passage of a variable-length ATM cell of minimum unit length×(m+1) identified by the cell-length indication RCC. The variable-length ATM cell CL is read out of the input buffer 21, passes through the switch 23 and is output to the output line of the destination within the length of the held time. It should be noted that cells enter the output lines from a plurality of input lines at this time interval.

ADM apparatus (Add/Drop Multiplexer)

FIG. 39 is a block diagram of an ADM (Add/Drop/Mux) transmission apparatus that is capable of being connected in ring form, and FIG. 40 is a diagram useful in describing the ring structure.

The ADM transmitting apparatus is terminal equipment having a MUX (multiplexing) function and an add/drop function. More specifically, the apparatus has a cross-connect function and an add/drop function for a lower order side (the tributary side). Line interfaces (LINE IF) 31a, 31b of working and protection channels, respectively, receive higher order signals (e.g., OC-3 optical signals) from optical transmission lines 38a₁, 38b₁ of working and protection channels, respectively, convert these signals to electrical signals and execute processing based upon overhead information. Demultiplexers (DMUX) 32a, 32b demultiplex higher order signals into lower order signals (e.g., STS-1 electrical signals), a cross-connect unit 33 performs cross-connect on the STS-1 level, multiplexers (MUX) 34a, 34b multiplex the cross-connected STS-1 signals into higher order signals and line interfaces (LINE IF) 35a, 35b of working and protection channels, respectively, add overhead to these higher order signals, convert the signals to optical signals and send the optical signals to optical transmission lines 38a₂, 38b₂ of working and protection channels, respectively.

The cross-connect unit 33 switches, on the STS level, STS-1 signals inserted from tributary interfaces 36a, 36b, . . . via MUX/DMUXs 37a, 37b, . . . and transmits these switched signals. The cross-connect unit 3 also drops signals, which have been received from the transmission path, on the tributary side, demultiplexes these signals to lower order signals of a prescribed speed via the MUX/DMUXs 37a, 37b, . . . and sends the signals to the tributary side from the tributary interfaces 36a, 36b, . . . . The transmitting apparatus normally transmits signals using the working channel. When a failure occurs, rescue is performed using a protection channel.

In accordance with the ring structure, ADM transmitters 30a to 30d are connected in the form of a ring, as shown in FIG. 40. If a certain transmission path develops a failure or suffers a decline in quality, signals are transmitted via the transmission path of the protection channel, thereby allowing communication to continue and assuring reliability and quality.

Recent Transmission Apparatus

With standardization of SONET (Synchronous Optical Network) and SDH (Synchronous Digital Hierarchy), the application of synchronous networks to optical transmission apparatus has proceeded in recent years. Further, when a large-scale network is constructed, service continuity and channel set-up flexibility are required. Further, with regard to subscriber data services, it is now so arranged that data is transmitted over a SONET network upon being converted to ATM cells. There is now demand for an optical transmission apparatus in which a data service other than the conventional basic service is accepted and mapped onto a SONET signal, whereby the data service can be transmitted to a LAN or WAN.

However, an optical transmission apparatus that can be applied to both a LAN and WAN has not yet been put into practice. That is, use is made of equipment whose specifications are different from those of an apparatus which performs cross-connect at the STS-signal level and routing of extended ATM cells, and an apparatus that supports both is not available.

Furthermore, on the STS-signal level of SONET, protection switches have been standardized and schemes that have been put into practice include path switches in which monitoring is performed on a path-by-path basis and line switches that are activated by the occurrence of failures. However, protection switches at the level of extended ATM cell signals have not yet been standardized nor put into actual practice.

With an increase in demand for Internet communications, the share of overall communication traffic occupied by data communication inclusive of IP packets has been increasing rapidly along with the amount of overall communication traffic. Communication providers also wish to construct networks optimized for IP but often have hesitated to introduce ATM owing to the shortcomings of fixed-length ATM cells discussed above. However, ATM possesses a rich QOS function and exhibits many excellent capabilities and characteristics such as congestion control, bandwidth assurance, versatility and the ability to construct efficient networks. (A bypass route can be set up flexibly when a failure is detected. In addition, unused lines can be used efficiently by statistical multiplexing.)

For these reasons, there has been discussion recently at ATM forums and at the IETF concerning the standardization of variable-length ATM cells of extended-cell length for the purpose of exploiting these ATM characteristics in IP packets and IP label switches (MPLS: Multiple Protocol Label Switch). However, methods of making concrete use of variable-length ATM cells in SONET/SDH transmission apparatus (inclusive of photonic transmission apparatus), apparatus architecture and methods of constructing the networks have not been put into practice.

A separate problem is that the conventional SDH transmission apparatus is constructed of tributary units to effect a conversion to VC-3, assembles an STM-1 from VC-4s obtained by collecting VC-3s together, and converts VC-4 stuff processing to TU stuff processing. As a consequence, with the conventional SDH transmission apparatus, it is impossible to realize high-speed data transmission having a transmission capacity greater than that of TUG-2. A particular problem is that high-speed data from high-speed terminal equipment or from an extended ATM apparatus cannot be sent to an SDH network.

### SUMMARY OF THE INVENTION

Accordingly, a first object of the present invention is to realize a transmission apparatus such as an ATM apparatus, SHD apparatus and ADM apparatus, as well as the related network, that is capable of dealing with variable-length cells in addition to already existing DS1, DS3, STS-1 and fixed-length cells.

A second object of the present invention is to provide a network and transmission apparatus capable of detecting failures and effecting recovery from such failures efficiently and rapidly even with regard to extended-cells in which fixed-length and variable-length cells are mixed or extended-cells in which the formats of fixed-length cells and variable-length cells are unified.

A third object of the present invention is to establish a protection technique applicable to extended-cells which support LANs and IP networks.

A fourth object of the present invention is to provide an SDH transmission apparatus capable of transmitting data between high-speed terminal equipment or an extended ATM apparatus and an SDH network.

According to the present invention, the first object is attained by providing a transmission apparatus for applying predetermined processing to and then transmitting extended-cells, comprising: (1) a receiver for receiving a frame signal from a transmission path; (2) a demultiplexing/demapping unit for demultiplexing and demapping extended-cells from a payload of the frame signal received from the transmission path; (3) a cell synchronizer for executing cell synchronization processing to identify an extended-cell boundary; (4) a controller for subjecting an extended-cell to switching and other control; (5) a multiplexing/mapping unit for multiplexing and mapping an extended-cell, which is output from the controller, onto a payload of a frame signal; and (6) a transmitter for transmitting this frame signal to a transmission path.

Further, according to the present invention, the first object is attained by providing an extended-cell communication network for transmitting extended-cells in which fixed-length and variable-length cells are mixed or extended-cells in which the formats of fixed-length cells and variable-length cells are unified, wherein a connection between the extended-cell communication network and a fixed-length-cell communication network is provided with (1) a conversion unit for allowing fixed-length cells to pass through both networks, converting variable-length cells to fixed-length cells and sending the fixed-length cells to the fixed-length-cell communication network, or (2) a conversion unit for converting between extended-cells and fixed-length cells and sending the resulting cells to a prescribed network.

According to the present invention, the second object is attained by providing a transmission apparatus of an extended-cell communication network for performing communication between a first transmission apparatus (node) and a second node using extended-cells and performing communication via a bypass route when a failure occurs, comprising: (1) a first VPI conversion table for converting a VPI of an extended-cell, which enters when communication is normal, to a VPI for a working virtual path; (2) a second VPI conversion table for converting a VPI of an extended-cell, which enters when the network develops a failure, to a VPI for a bypass virtual path; (3) a conversion table creation unit for creating the first and second VPI conversion tables; (4) conversion table distribution means for reorganizing the first and second VPI conversion tables node by node and distributing the reorganized first and second VPI conversion tables to each of the nodes; and (5) means for setting up one bypass-route monitoring control virtual path for each bypass route and sending a monitor cell to each bypass route via the bypass-route monitoring control virtual paths.

According to the present invention, the third object is attained by providing an add/drop multiplexing apparatus for extracting a signal of a low-order communication network from a signal received from a high-order transmission path, inserting a signal that enters from the low-order communication network and sending the signal to the high-order transmission path, comprising: (1) a receiver for receiving a frame signal from the high-order transmission path; (2) a cross-connect unit for cross connecting a signal, which has been mapped onto a payload of the frame signal received by the receiver, and extracting a prescribed signal; (3) a tributary interface for converting the signal, which has been extracted by the cross-connect unit, to a signal format that corresponds to the low-order communication network; and (4) a transmitter for mapping a signal, which has been cross connected by the cross-connect unit, onto a payload of a frame signal and sending this frame signal to the high-order transmission path; wherein the tributary interface converts an extended-cell, which has been received from the low-order communication network, to a signal format capable of being processed by the cross-connect unit, converts a signal, which has been output from the cross-connect unit, to an extended-cell and sends the extended-cell to the low-order communication network.

According to the present invention, the fourth object is attained by providing an SDH transmission apparatus for sending and receiving a virtual container, which is obtained by gathering data from a low-speed side, upon mapping the virtual container onto a payload of a transmit-frame signal, comprising: (1) SOH terminating equipment for inserting/separating section overhead of a transmit-frame signal and performing a conversion between a virtual container and the transmit-frame signal; (2) POH terminating equipment for inserting/separating path overhead POH of a virtual container and implementing synchronous operation of the virtual container by stuff processing of the virtual container; (3) a high-speed terminal interface or extended ATM interface for interfacing a high-speed terminal or extended ATM apparatus; and (4) a selector for selecting data from the low-speed side and data from a high-speed terminal or extended ATM apparatus and connecting the selected data to the POH terminating equipment.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram useful in describing an extended-cell communication network according to the present invention;

FIG. 2 is a block diagram of an extended ATM cell apparatus;

FIG. 3 is a diagram useful in describing a layer structure;

FIG. 4 shows the format of a CS-PDU in CS;

FIG. 5 shows the format of SAR-PDU in an SAR sublayer;

FIGS. 6A and 6B are diagrams showing the structures of an ATM cell and ATM cell header, respectively;

FIG. 7 is a diagram showing the structure of an extended ATM switch;

FIG. 8 is a diagram showing the structure of a table for identifying out-route numbers;

FIGS. 9A and 9B are diagrams useful in describing a method of establishing synchronization in a physical layer (in the case of variable-length cells);

FIGS. 10A and 10B are diagrams useful in describing identification of cell boundary and a method of extracting cells;

FIGS. 11A and 11B are diagrams useful in describing the NNI between fixed-length cells and a network;

FIG. 12 is a diagram useful in describing a conversion between variable-length cells and fixed-length cells in an NNI;

FIG. 13 is a block diagram of an SDH transmission apparatus;

FIG. 14 is a diagram showing the configuration of a network useful in describing protection control at occurrence of a failure;

FIG. 15 is a diagram useful in describing preliminary design of a bypass virtual path;

FIG. 16 is a diagram useful in describing virtual-path partitioning of a link;

FIG. 17 is a flowchart illustrating the creation and the distribution of VPI conversion tables;

FIG. 18 illustrates a VPI conversion table;

FIG. 19 is a diagram in which a plurality of bypass virtual paths have been set in a common bypass virtual path link;

FIG. 20 is a block diagram of a premap switching system;

FIG. 21 is a diagram showing an operation sequence;

FIG. 22 is a schematic view showing the configuration of a network to which a SONET ADM unit is applied;

FIG. 23 is a diagram showing the internal structure of a SONET ADM unit;

FIG. 24 is a diagram showing the internal structure of a tributary interface for a LAN;

FIG. 25 is a functional block diagram of the protection channel of a SONET ADM unit;

FIG. 26 is a diagram showing a specific example of an OAM cell for protection;

FIG. 27 is a diagram showing a specific example of a ring-map PDU;

FIG. 28 is a diagram showing a specific example of a VC table established on SONET;

FIG. 29 is a diagram showing a specific example of a switch MAP established on SONET;

FIG. 30 is a diagram showing an example of implementation of a protection switch at occurrence of a failure;

FIG. 31 is a diagram showing the relationship between an IP packet and ATM cells according to the prior art;

FIG. 32 is a diagram useful in describing a SONET or SDH frame format according to the prior art;

FIG. 33 is a diagram useful in describing an SDH multiplexing method according to the prior art;

FIG. 34 is a block diagram showing an SDH transmission apparatus according to the prior art;

FIG. 35 is a diagram useful in describing conversion of VC-4 stuff processing to TU stuff processing according to the prior art;

FIG. 36 is a diagram useful in describing variable-length ATM according to the prior art;

FIG. 37 is a diagram illustrating processing of variable-length ATM cells according to the prior art;

FIG. 38 illustrates the header of a variable-length ATM cell according to the prior art;

FIG. 39 is a block diagram illustrating an ADM transmission apparatus according to the prior art; and

FIG. 40 is a diagram showing the structure of a ring according to the prior art.

### DESCRIPTION OF THE PREFERRED EMBODIMENT

(A) Extended-Cell Communication Network

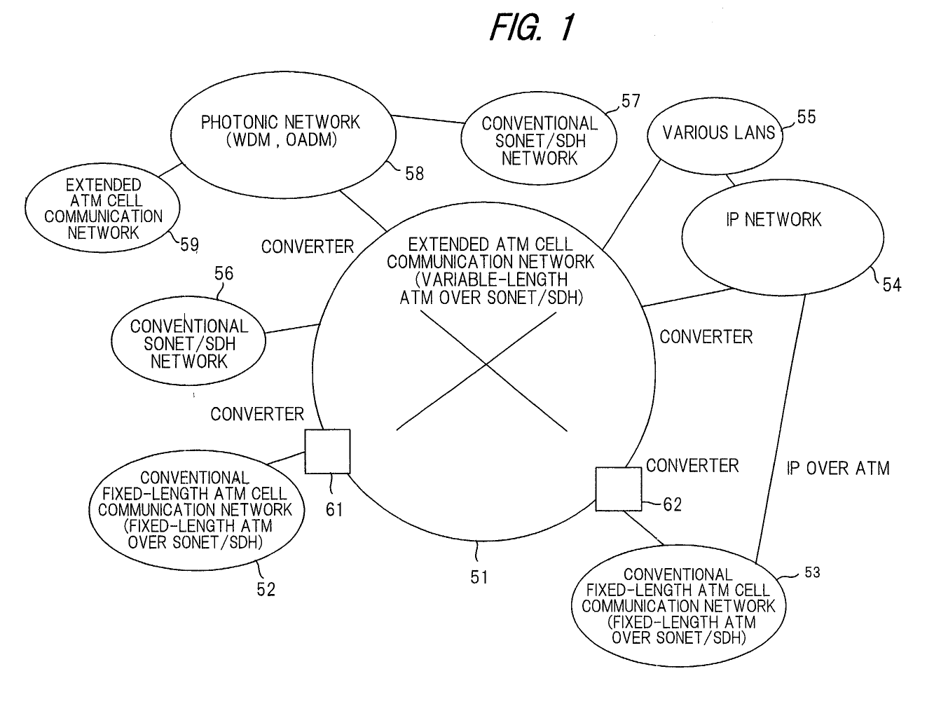

FIG. 1 is a diagram useful in describing an extended-cell communication network according to the present invention. Numeral 51 denotes an extended ATM cell communication network for transmitting extended ATM cells in which fixed-length ATM cells and variable-length ATM cells are mixed. This is an extended ATM over SONET/SDH network for transmitting extended ATM cells upon mapping them onto the payload of a SONET or SDH frame signal. Numerals 52, 53 denote fixed-length ATM cell communication networks for transmitting fixed-length ATM cells. These are fixed-length ATM over SONET/SDH networks for transmitting fixed-length ATM cells upon mapping them onto the payload of a SONET or SDH frame. Numeral 54 denotes an IP network, 55 various LANs, 56, 57 conventional SONET/SDH networks, 58 a photonic (WDM, OADM) network and 59 another extended ATM cell communication network.

The conventional fixed-length ATM cell communication networks 52, 53 are connected to the extended ATM cell communication network 51 via conversion units 61, 62, respectively. Also connected to the extended ATM cell communication network 51 are the IP network 54, various LANs 55, conventional SONET/SDH network 56 and photonic network 58. The conversion units 61, 62 are provided at the connections between the extended ATM cell communication network 51 and fixed-length ATM cell communication networks 52, 53, respectively. The conversion units 61, 62 allow fixed-length cells to pass through in both directions and convert variable-length cells to fixed-length cells and send the fixed-length cells to the fixed-length ATM cell communication networks 52, 53, respectively. However, if an extended ATM cell is obtained by unifying the formats of fixed-length and variable-length cells in the extended ATM cell communication network 51, the conversion units 61, 62 convert extended-cells from the extended ATM cell communication network 51 to fixed-length cells and send the fixed-length cells to the fixed-length ATM cell communication networks 52, 53, respectively. Further, the conversion units 61, 62 convert fixed-length cells from the fixed-length ATM cell communication networks 52, 53 to extended-cells and send the extended-cells to the extended ATM cell communication network 51.

A conversion unit between the extended ATM cell communication network 51 and IP network 54 has been deleted. However, if an IP packet is regarded as user data, then IP packets can be converted to extended-cells, and vice versa, and the resulting data can be transmitted, in accordance with the method described above in connection with FIG. 36. Other network data can be converted to extended ATM cells in the same manner.

(B) Extended ATM Cell Transmission Apparatus

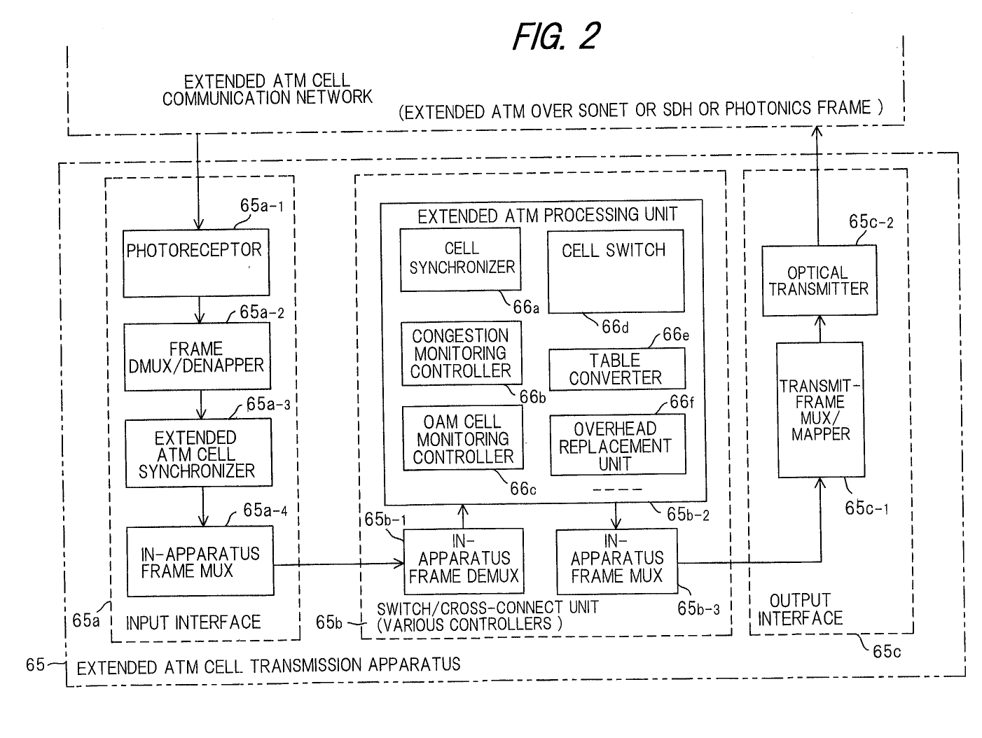

FIG. 2 is a block diagram illustrating a transmission apparatus (an extended ATM cell transmission apparatus) 65, which is provided in the extended ATM cell communication network. The apparatus includes an interface 65a on the input side, various controllers (switch/cross-connect unit) 65b and an interface 65c on the output side.

The input-side interface 65a includes a photoreceptor 65a-1 for converting a high-speed optical signal, which enters from an optical transmission path, to an electric signal, and for extracting overhead from an SDH frame and executing predetermined processing based upon this overhead; a frame demultiplexing/demapping unit 65a-2 for demultiplexing and demapping extended ATM cells from a payload of the SDH frame signal; an extended ATM cell synchronizer 65a-3 for executing cell synchronization processing; and an in-apparatus frame multiplexer 65a-4 for transmitting extended-cells upon multiplexing them onto the payload of a low-speed frame signal.

The various controllers 65b include an in-apparatus frame demultiplexer 65b-1 for demultiplexing extended ATM cells from a low-speed frame signal and inputting the cells to the various controllers, and an extended ATM processing unit 65b-2. The extended ATM processing unit 65b-2, which has a cell synchronizer 66a, a congestion monitoring controller 66b, an OAM cell monitoring controller 66c, a cell switch 66d, a VPI/VCI conversion table 66e and an overhead replacement unit 66f, executes ATM cell processing similar to the processing applied in ordinary fixed-length ATM. The various controllers 65b further include an in-apparatus frame multiplexer 65b-3 for transmitting extended ATM cells upon multiplexing them onto low-speed frame signals.

The output-side interface 65c includes a transmit-frame multiplexing/mapping unit 65c-1 for multiplexing and mapping a low-speed frame signal onto the payload of a high-speed SDH frame signal, and an optical transmitter 65c-2 for adding overhead onto the high-speed SDH frame and sending the frame to an optical transmission path.

Though the cell synchronization method will not be described until later, the objectives of cell synchronization using the interface 65a are as follows:

The first objective is adjustment of cell flow rate. Cells are buffered by the interface in conformity with the processing speed of the ATM switch so that the capacity of the switch will not be exceeded. This reduces the load upon the switch. Further, though the switch also possesses a buffer, adjustment of flow rate is not left solely to the switch and buffering is distributed, thereby raising the shaping capability of the overall apparatus. Further, it is possible to deal not only with cases in which cell flow rate is too high but also cases in which it is too low. By inserting idle cells in the latter case, cell flow rate managed by the switch can be rendered constant to facilitate processing. In addition, when alarm information has been impressed upon a physical-layer signal, alarm detection/processing is performed rapidly so that the necessary processes may be implemented by the apparatus, thereby lightening the load upon the switch.

A second objective is to make it possible to change over containers for transporting extended ATM cells. For example, when an extended ATM cell is placed on a PDH signal referred to as a DS3, the DS3 frame is removed by a line interface, cell synchronization is performed and the extended ATM cell can be placed on an SDH or SONET STM-n or STS-n/OC-n frame. Similarly, a change can be made from a PDH signal or SONET/SDH signal to a photonic frame or new frame such as an IP over WDM frame, or in the opposite direction. Alternatively, when nodes have been connected by an in-apparatus special-purpose frame compliant with STS-12 or STS-48, a change between external signals and signals within the apparatus can be made by achieving cell synchronization.

(C) Flow of Data Through Extended ATM Cell Communication Network

(a) Layer Structure

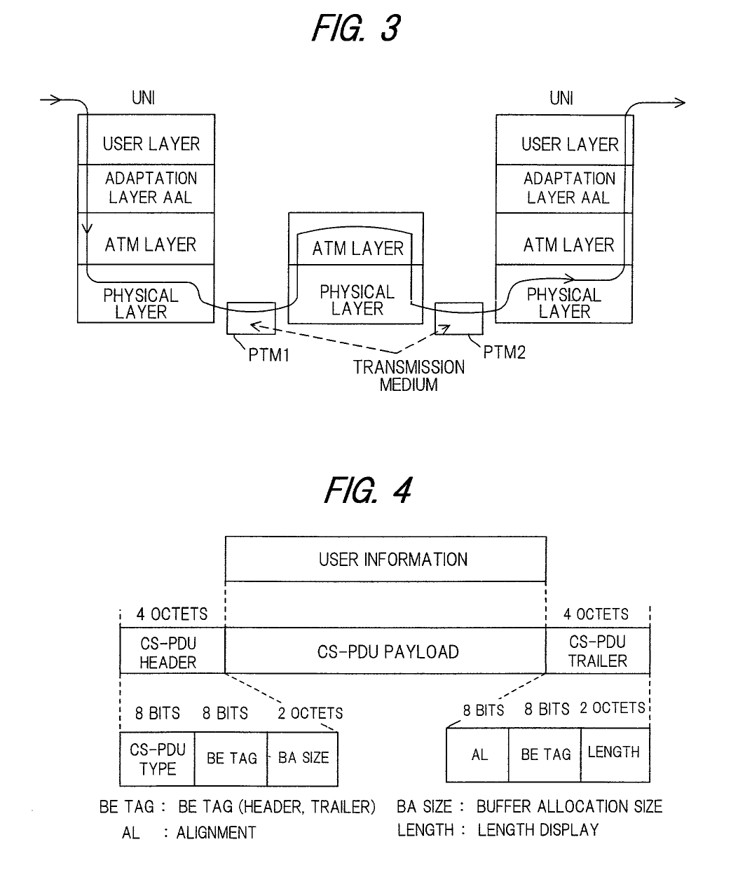

FIG. 3 is an explanatory view illustrating the layer structure of various portions in accordance with the flow of user data. In a UNI (User Network Interface), as shown in FIG. 3, user data that has entered from a user layer is subjected to processing via an adaptation layer (AAL) and ATM layer and is then transmitted to a transmission medium PTM1 by a physical layer. Data that has been sent to the transmission medium is subjected to predetermined ATM-layer processing in the network, the processed data is transmitted to a transmission medium PTM2 by the physical layer, processing is applied successively from the physical layer to the higher order layers of another UNI and the user layer thereof outputs the user data in its original form.

A user function is implemented in the user layer and functions such as flow control/error control, accommodation for fluctuations in call transport and cell disassembly/assembly are implemented in the adaptation layer. Functions such as cell transport (VPI/VCI routing and multiplexing) and generation/extraction of cell headers are implemented in the ATM layer. Cell flow rate adjustment/cell synchronization, verification/correction of HEC (Header Error Control) sequence, control of bit timing and control of physical media, etc., are executed in the physical layer. The foregoing is identical with the fundamentals of an ATM network. The approach is similar even in extended ATM networks.

(b) Data Structure in each Layer

The data structure in each of the above-mentioned layers will now be described. Though an example in which n is equal to six octets will be described, operation can be performed in similar fashion even if n is equal to seven or eight octets.

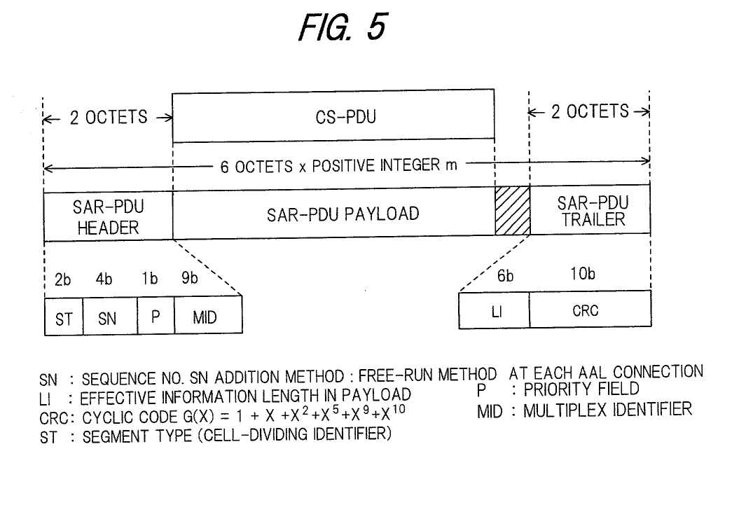

The adaptation layer (AAL) shown in FIG. 3 is composed of a convergence sublayer (CS) and SAR sublayer in a manner similar to that of the prior art. FIG. 4 illustrates the format of CS-PDU, which is a data unit, in CS, and FIG. 5 illustrates the format of SAR-PDU. The format of CS-PDU shown in FIG. 4 uses an arrangement that is compliant with the specifications of IEEE 802.6. The user information of the higher layer is stored in the payload of CS-PDU (Convergence Sublayer-Protocol Data Unit) as is, a 4-octet CS-PDU header is added to the beginning of the payload, a 4-octet trailer is added to the end of the payload, and the content of each, which is shown in FIG. 4, is stipulated by the specifications.

FIG. 5 shows the format of the data unit handled by the SAR sublayer, which is the next lower layer of the AAL. In the SAR sublayer of conventional fixed-length cells, a CS-PDU is disassembled into a fixed length (48 octets) or is assembled. In the SAR sublayer of this embodiment, however, a CS-PDU is not disassembled. Rather, as shown in FIG. 5, the entire CS-PDU is stored in the payload of the SAR sublayer, a 2-octet SAR-PDU header is added to the beginning of the payload, a 2-octet SAR-PDU trailer is added to the end of the payload, and the length of the SAR-PDU payload is adjusted in such a manner that the overall data length will become a length that is a whole-number multiple of six octets (n=6), which is the minimum transport unit. More specifically, in case of a length that cannot be divided by six octets, the entire CS-PDU is stored in the SARPDU payload six octets at a time, and then invalid data is added to the final remaining data to adjust (pad) the payload length so as to obtain six octets. In the example of FIG. 5, invalid data indicated by the hatching is added to the payload of the SAR-PDU. The number of octets of invalid data that need to be added on is five at most. It will be understood that this number is very small in comparison with a scheme in which a maximum of 47 octets of invalid data is added on, as in the case of fixed-length ATM cells according to the prior art. As a result of the foregoing, the overall length of the SAR-PDU is 6 octets×positive integer (m).

Further, as illustrated in detail in FIG. 5, the formats of the header and trailer of the SAR-PDU are the same as those of a fixed-length cell but they differ as follows: Though the indication of the effective information length LI of the payload contained in the trailer is provided in order that the boundary between the valid and invalid data may be distinguished, only six bits have been allocated. As a consequence, the effective information length in the payload of the SAR-PDU cannot be expressed if this length exceeds 63 octets. Accordingly, if the effective information length exceeds 44 octets, the payload length is divided by 44 and the value of the remainder [mod 44)] is indicated in LI. As a result, the effective payload length within the SAR-PSU payload can be represented even with regard to variable-length information.

(c) Structure of Variable-Length ATM Cell

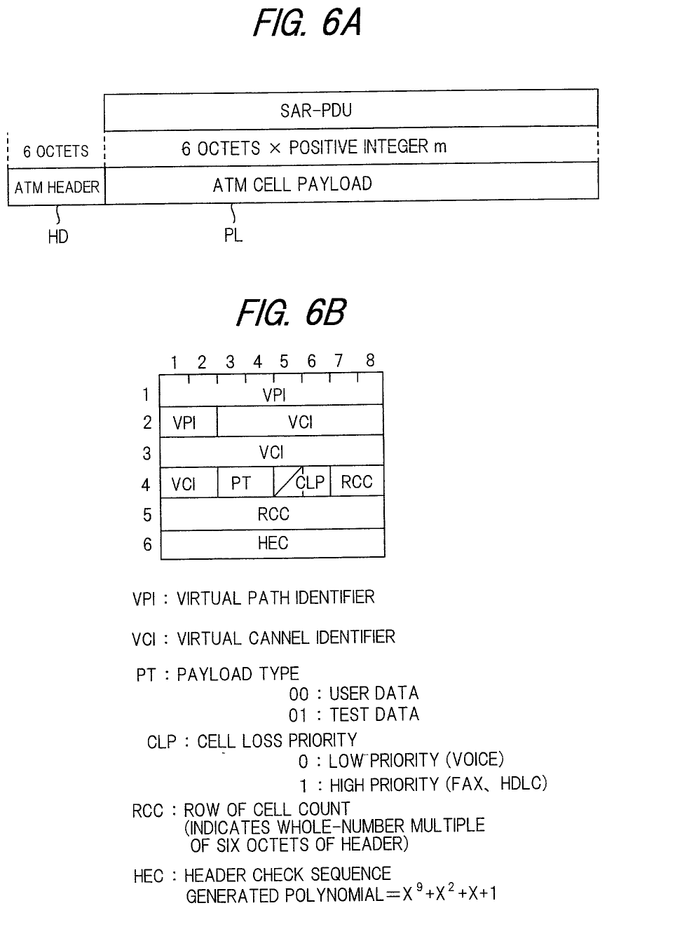

FIGS. 6A and 6B are diagrams showing the structure of a variable-length ATM cell in the ATM layer in accordance with the present invention, in which FIG. 6A illustrates the structure of an ATM cell and FIG. 6B the structure of an ATM cell header. As shown in FIG. 6A, the ATM cell is such that the entire SAR-PDU (inclusive of the header and trailer) having the format shown in FIG. 5 is stored in the ATM cell payload PL, and a 6-octet ATM header HD is added to the beginning of the payload. An amount of data equivalent to 6 octets×positive integer (m) is stored in the ATM cell payload PL, as described above in connection with FIG. 5. The 6-octet ATM header has the structure shown in FIG. 6B. This header differs from the fixed-length ATM cell header in that a cell length indication (RCC: Row of Cell Count) expressed by ten bits is provided. In the case indicated at FIG. 6A, the value of RCC is the integer m (no header is included) or m+1 (a header is included).

(d) Structure of Extended ATM Switch

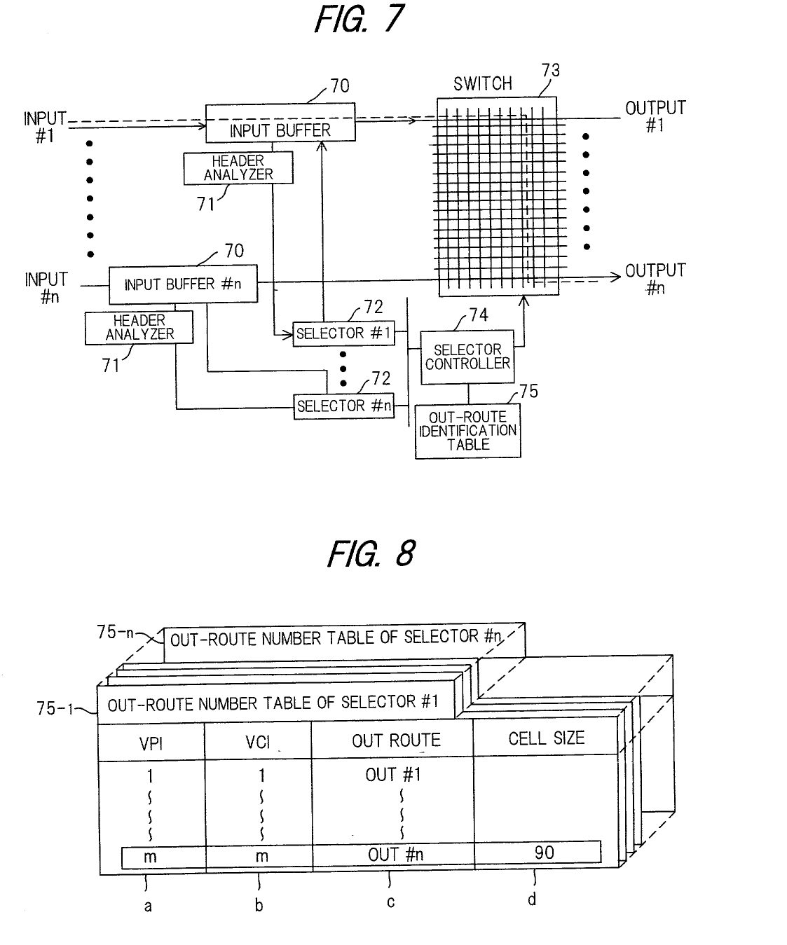

FIG. 7 is a diagram showing the structure of an extended ATM switch (which corresponds to the cell switch 66d in FIG. 2). The switch includes input buffers 70 provided for corresponding ones of input lines #1 to #n; header analyzers 71, which are provided for respective ones of the buffers 70, for storing ATM cells; and selectors 72, which are provided for respective ones of the input lines #1 to #n, for extracting VPI, VCI from the corresponding header analyzers based upon header analysis, and for specifying output of ATM cells from corresponding buffers 70 in response to a command from a selector controller 74, described later; and a routing table (out-route identification table) 75 used by the selector controller 74 to control the switch 73.

The operation of the extended ATM switch shown in FIG. 7 will now be described.

(1) An extended ATM cell enters from input line #1.

(2) The ATM cell is saved temporarily in the input buffer (#1) 70.

(3) The header analyzer 71 analyzes VPI, VCI and RCC (the indication of cell length) and reports the results to the selector (#1) 72. In a case where the input ATM cell is a conventional fixed-length cell, this cell is subsequently subjected to processing for dealing with fixed-length cells in the conventional manner. The description rendered below is based upon input of a variable-length ATM cell.

(4) The selector controller 74, which manages each of the selectors 72 (#1 to #n), at this time recognizes that a selector requesting a VPI identical with that of selector #1 does not exist. Next, the selector controller 74 indexes the out-route identification table 75 and assigns an out route. As shown in FIG. 8, the out-route identification table 75 has out-route number tables 75-1, . . . , 75-n corresponding to the selectors #1 to #n, respectively. Out-route numbers indicated by c are set in each out-route number table in correspondence with combinations of numbers of VPI indicated by a and VCI indicated by b. The selector controller 74 uses this table to assign out-route numbers based upon the VPI, VCI from the header analyzers.

(5) If the selector controller 74 has assigned an out-route number, it enters the RCC (indication of cell length) acquired from the header analyzer in a cell-size column d of the out-route number table. In FIG. 8, 90 is set as the RCC (RCC=m=90). Next, the switch 73 is controlled in accordance with the out-route number table to connect the input #1 with the output #n.

(6) If the selector controller 74 has reserved the route between the input #1 and the output #n, it sends a cell transmit command to the input buffer (#1) 70 via the selector (#1) 72.

(7) The selector controller 74 holds the route between input #1 and output #n of switch 73 to assure cell transport for a period of time that corresponds to the RCC value (m=90) in cell-size column d [more exactly, for a period of time equal to (time needed for six octets, which is the minimum cell-length unit, to pass through the switch)×(90+1)].

(8) When the time based upon cell size has elapsed, the selector controller 74 cancels the route between input #1 and output #n of switch 73, ends the transport of one cell and clears the relevant columns of the out-route number table. Processing similar to the above is executed with regard to input ATM cells at input ports #2 to #n.

(9) Thus, in a switch relating to variable-length ATM, the entirety of one cell is handled collectively adopting the ATM header length (six octets in this example) as the unit, whereby switching is performed up to a maximum of 6144 octets [6 octets×(1023+1)] in a case where the RCC area is composed of ten bits.

By expressing a fixed-length ATM cell and a variable-length ATM cell using the same format, processing can be executed without distinguishing between fixed length and variable length. However, in a case where fixed-length ATM cells and variable-length ATM cells are not expressed in the same format, each cell is identified when the mixed cells enter the switch, and each fixed-length cell is then processed in conventional fashion.

(e) Cell Synchronization Mechanism

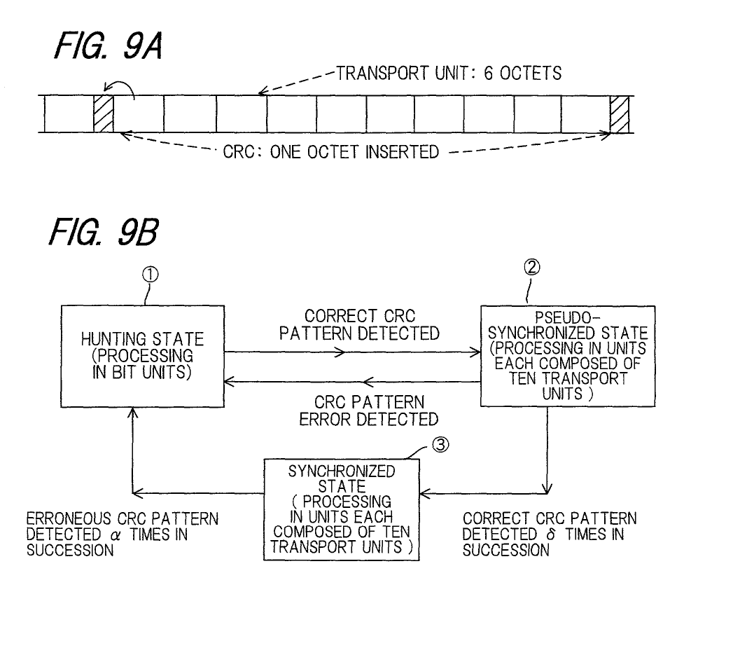

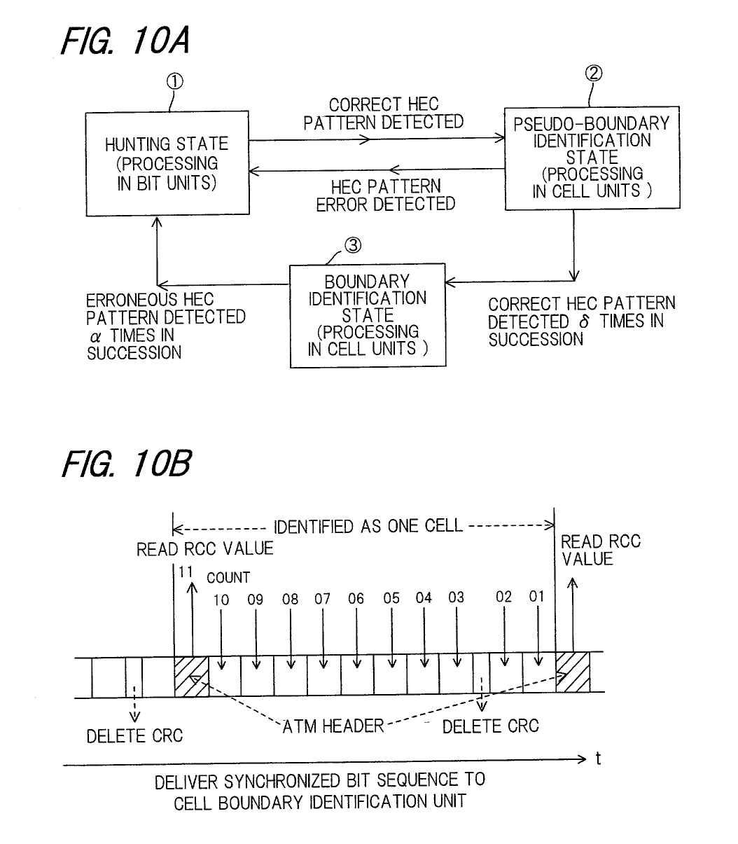

FIGS. 9A and 9B are diagrams useful in describing synchronization of variable-length cells in a physical layer, and FIGS. 10A and 10B are diagrams useful in describing identification of cell boundary and a method of extracting cells. The mechanism of cell synchronization for identifying cell boundary from cell flow will be described with reference to these drawings. It should be noted that since there is already an established technique regarding a mechanism for synchronizing conventional fixed-length ATM cells, only an operation for synchronizing variable-length ATM cells will be described.

In a case where a variable-length ATM cell for which six octets is the smallest unit is transported, it is necessary to identify the boundary of the 6-octet transport unit. To accomplish this, this embodiment creates a 1-octet cyclic code (CRC: Cyclic Redundancy Check) every ten transport units of six octets and adds on the code to the immediately preceding transport unit (six octets). In this case, a CRC can also be created and added on to two transport units, namely the immediately preceding transport unit (six octets) and the transport unit which precedes it.

In order to thus establish synchronization by detecting a 6-octet transport unit from the signal of a physical layer into which a CRC has been inserted, the method described below is used. FIG. 9B is a diagram showing state transition used in identifying the boundary of the transport unit. In a case where boundary identification (synchronization) is performed based upon the signal shown in FIG. 9A, the initially prevailing state is a hunting state, which is indicated at \mathring{1}. This is a state of non-synchronization, namely a state in which the boundary of the transport unit is being searched by bit processing. At this time the six octets serving as the transport unit in this embodiment are checked bit by bit to determine whether the CRC code rule applies thereto. If one is not found, similar processing is executed shifting the beginning by one bit and the check is carried out while successively executing the shift one bit at a time.

Once a state that applies to the CRC code rule is detected, it is assumed that one transport unit has been detected and a transition is made to a pseudo-synchronized state, which is indicated at \mathring{2}. In the pseudo-synchronized state, processing for transport-unit synchronization is repeated until the CRC code rule is verified δ times in succession in units of ten transport units. Agreement δ times, which is the requirement for the transition to the synchronized state, is referred to as the number of backward protection steps. If the CRC code rule is verified δ times, the synchronized state indicated at \mathring{3} is attained. If the CRC code rule is erroneous a times in succession in units of ten transport units, then the transport units are regarded as not being in synchronization. Non-agreement α times, which is the requirement for return to the hunting state, is referred to as the number of forward protection steps. The synchronized state \mathring{3} and the pseudo-synchronized state \mathring{2} can be referred to collectively as synchronized states in the broad sense. The above-described state-transition process is almost exactly the same as the process in the case of conventional fixed-length cells. What differs is whether the transport unit is made a fixed length of 53 octets or six octets every ten 6-octet units. Further, if the conventional fixed-length cell is a unit of 53 octets and the transport unit can be identified, then the cell boundary can be identified.

When synchronization of the transport units has been achieved, then identification of the variable-length ATM cell boundary is carried out. FIGS. 10A and 10B are diagrams useful in describing identification of cell boundary and a method of extracting cells. In this embodiment, since the size of the transport unit is six octets, the boundary of a variable-length ATM cell is identified by detecting an HEC (see FIG. 6B) pattern in the header (six octets) of an ATM cell.

As shown in FIG. 10A, which illustrates the state transition in cell boundary identification, initially the state is one in which a cell boundary cannot be determined and therefore the state is hunting at \mathring{1}. In this case, if it is assumed that each transport unit (six octets) is a header, then it is determined, for every transport unit, whether or not the sixth octet applies as the HEC of the preceding first to fifth octets. Once this state is detected, it is assumed that the first cell has been detected and a transition is made a pseudo-boundary recognition state, which is indicated at \mathring{2}.

When the pseudo-boundary recognition state is attained, boundary recognition processing on a per-cell basis is executed using the value of the cell-length indication (RCC) contained in the detected ATM header. That is, the cell-length indication (RCC) is information representing the number of transport units (six octets). If transport units following the header detected as the boundary are received, the transport units are counted successively. When transport of m units has been counted, it is judged that one cell has been received and the cell is delivered to the ATM layer. If a cell boundary is detected correctly, the HEC (cell boundary) can be detected from the next transport unit (six octets) for which transport has been completed.

Thus, in the pseudo-boundary recognition state, cell boundary identification is repeated until a correct HEC is detected δ times in succession. When the cell boundary is detected, a transition is made to a boundary recognition state, which is indicated at \mathring{3} in FIG. 10A. HEC agreement δ times, which is the requirement for the transition to the boundary recognition state, is referred to as the number of backward protection steps. In the boundary recognition state \mathring{3}, processing for detecting an ATM cell and delivering the cell to the ATM layer is executed, as shown in FIG. 10B, based upon recognition of the HEC pattern in a manner similar to that of the pseudo-boundary recognition state. However, if the HEC code is erroneous for α-number of cells in succession, it is judged that the cell boundary has been overlooked and the state returns to the hunting state \mathring{1} \mathring{1}. Non-agreement of the HEC code α times, which is the requirement for return to the hunting state \mathring{1}, is referred to as the number of forward protection steps. The pseudo-boundary recognition state \mathring{2} and the boundary recognition state \mathring{3} can be referred to collectively as boundary recognition states in the broad sense.

(f) Device Connecting Extended ATM Cell Communication Network and Other Network

Device Connecting Extended ATM Cell Network and Fixed-Length Cell Communication Network

If a cell is a fixed-length cell, the conversion units 61, 62 (see FIG. 1) allow the cell to pass therethrough. Basically, signals from a fixed-length network to an extended ATM network also merely pass through. In case of an extended ATM cell, the SAR-PDU header and CS-PDU header are removed from the payload of the extended ATM cell, the format up to the user information is maintained and the processing of the AAL layer and ATM layer is subsequently executed to create a fixed-length ATM cell.

FIG. 11A illustrates an NNI based upon the ATM adaptation layer (AAL). The left side of FIG. 11A is a transport network that uses variable-length cells, and the right side is a transport network of fixed-length cells. If a variable-length cell enters the NNI, a conversion is made to data of the physical and ATM layers in succession. When the data is returned to the AAL convergence sublayer (CS), the structure obtained is identical with that of the AAL (CS layer) in the case of the fixed-length cell, as shown in FIG. 4. Accordingly, after the data of the variable-length cell is returned to the AAL convergence sublayer (CS), it is converted to an ATM cell by processing of the fixed-length ATM layer (an already existing 53-octet ATM cell) and this ATM cell is sent to the physical layer of the fixed-length cell. By virtue of the foregoing operation, 53-octet fixed-length cells are transported successively to the transport network of fixed-length cells.

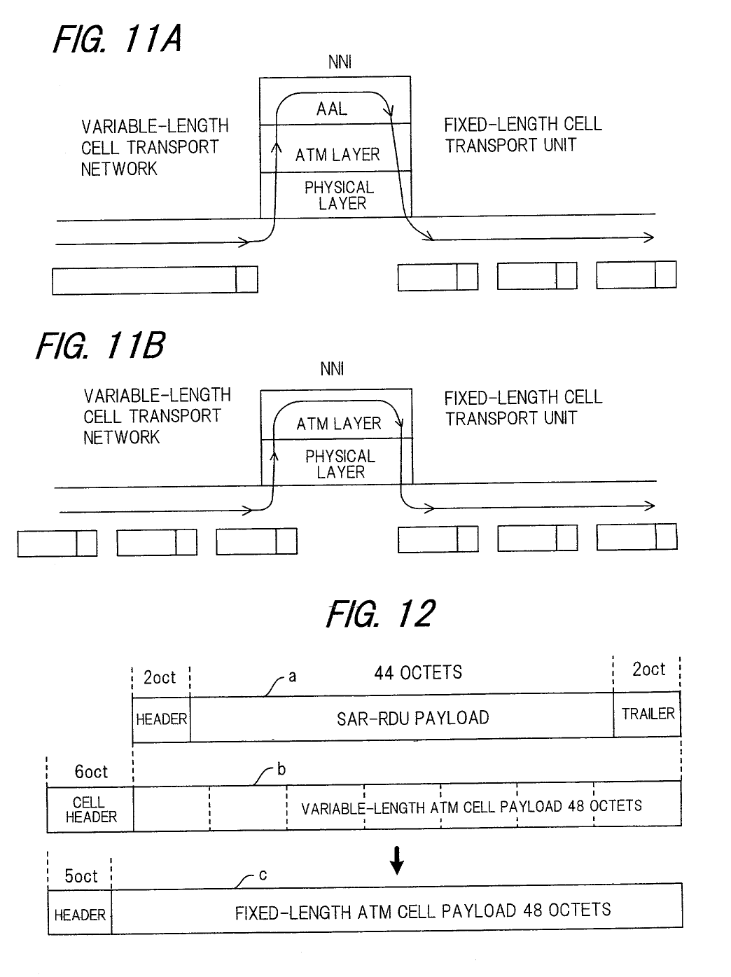

FIG. 11B illustrates an NNI based upon the ATM layer. The left side of FIG. 11B is a transport network that uses variable-length cells, and the right side is a transport network of fixed-length cells. The NNI subjects the transport data only to processing up to the ATM layer. More specifically, when a variable-length cell is received, the NNI replaces the header of the received cell with the header of a fixed-length cell and forwards the received cell to the network of the fixed-length cell. It is required, therefore, that the payload length of the variable-length cell forwarded be made 48 octets, which is the same as that of the fixed-length cell, as shown in FIG. 12. The header, however, is five octets.

It should be noted that if the formats of a fixed-length ATM cell and variable-length ATM cell are made the same, or in other words, if fixed-length ATM cells are not passed through the extended ATM network, i.e., if only extended ATM cells having a variable-length ATM format are passed through the extended ATM network, then a conversion unit is provided for performing a conversion between fixed-length ATM cells and variable-length ATM cells (extended ATM cells) in both directions of the extended ATM cell network and fixed-length cell communication network.

Device Connecting IP Network and Extended ATM Network

In a case where user information is an IP packet, i.e., a case where an IP network and an extended ATM network are connected, it will suffice merely to store the user information in a lower layer referred to as an extended ATM layer. It does not matter whether this is IP over PPP over extended ATM or IP over MPLS over extended ATM. Since a conventional fixed-length cell is shorter than an IP packet, it is decomposed using the SAR structure and must be transported with 10% waste associated with the ATM cell. By contrast, with the extended ATM cell of large cell length, the IP packet is transmitted highly efficiently and the QoS of the IP can be enhanced using the excellent QoS function of ATM.

(D) Simplified Structure of Extended-Cell Communication Network

Cell length of a variable-length ATM cell in an extended ATM cell communication network is fixed at a cell length that is optimum for storing IP packets, and processing of extended ATM cells is limited to two types, namely processing of a fixed-length ATM cell (53 octets) and processing of the variable-length ATM cell. As a result, an efficient, low-cost network device is realized. Alternatively, the overall extended ATM cell is fixed at a cell length of one type that is optimum for storing IP packets, thereby improving efficiency and lowering cost.

According to this idea, an IP packet or an MPLS in which a label has been attached to an IP packet is assumed to be the data stored in the payload of a variable-length ATM cell, and the length of this variable-length cell is limited to a length that is optimum for an IP packet or MPLS. As a result, processing is reduced and economical transmission of extended ATM cells is realized.

If a conventional fixed-length ATM cell and this variable-length ATM cell of limited length are transported, the ATM processing unit can be constructed more simply. For example, the ATM processing unit can be constructed more simply because it will suffice merely to identify fixed-length ATM cells and variable-length ATM cells and execute processing suited to the cells identified. Further, with an extended ATM network which transports mainly IP packets, it is possible to adopt a technique in which cells are transmitted upon unifying cell length to that optimized for storing IP packets. This also includes situations in which the network accommodates conventional fixed-length ATM.

(E) SDH Transmission Apparatus Capable of High-Speed Data Transmission

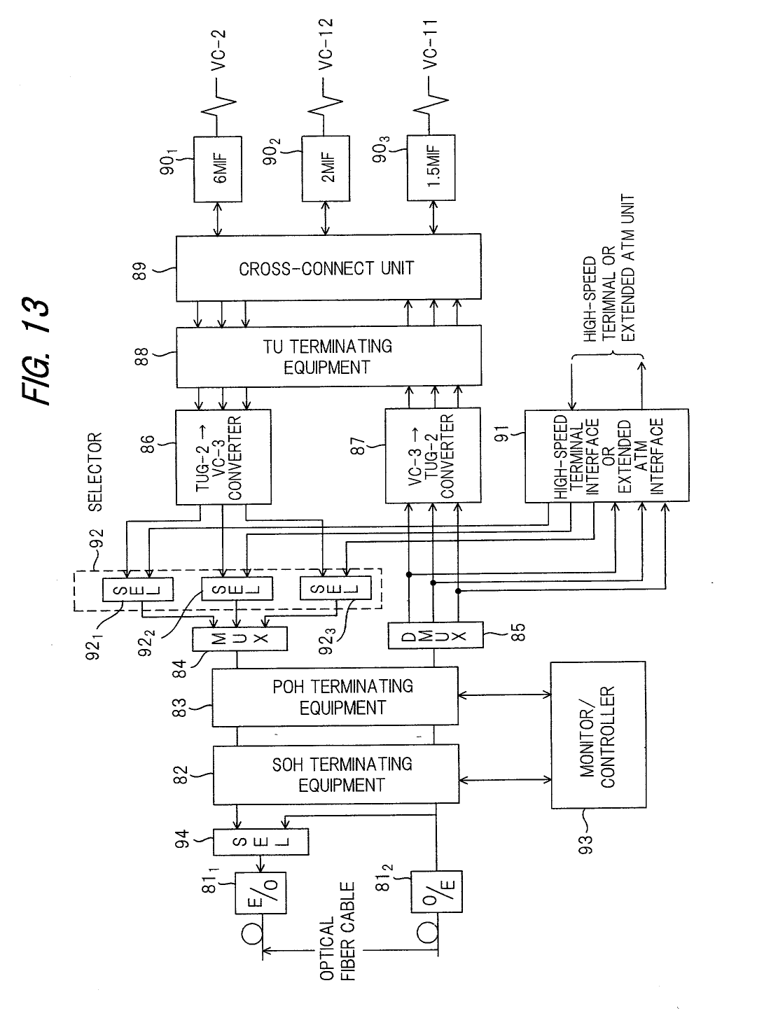

FIG. 13 is a block diagram of an SDH transmission apparatus according to the present invention. The apparatus includes an electro-optic transducer (E/O) 81₁; an optoelectronic transducer 81₂; SOH terminating equipment 82 for inserting/separating STM-1 section overhead SOH; POH terminating equipment 83 for inserting/separating virtual container VC-4 path overhead POH and for executing virtual container VC-4 stuff processing; a multiplexer (MUX) 84 for multiplexing three virtual containers VC-3s and converting them to a virtual container VC-4; a demultiplexer (DMUX) 85 for demultiplexing a virtual container VC-4 and converting it to three virtual containers VC-3s; a TUG-2→VC-3 converter 86 for converting a tributary unit group TUG-2 to a virtual container VC-3; a VC-3→TUG-2 converter 87 for converting a VC-3 to a TUG-2; TU terminating equipment 88 for terminating TUG-2 data; a cross-connect unit 89 for cross-connecting low-speed data in VC-11, VC-12 or VC-2 units; and low-speed interfaces 90₁ to 90₃ for interfacing data on a low-speed side. More specifically, characters 90₁ to 90₃ denote a 6 M interface (IF) for interfacing 6-MHz data (VC-2), a 2 M interface (IF) for interfacing 2-MHz data (VC-12), and a 1.5 M interface (IF) for interfacing 1.5-MHz data (VC-11). The apparatus further includes a high-speed terminal interface of extended ATM interface 92, and monitor/controller 93 for collecting SOH, POH from the terminating equipment, and a loop-back selector 94.

During ordinary operation, the selector 94 is switched over to the side of the SOH terminating equipment 82. The cross-connect unit 89 receives the 6-, 2- and 1.5-MHz data on the low-speed side via the 6MIF 90₁, 2MIF 90₂ and 1.5MIF 90₃, respectively, and performs cross connect in units of VC-1 or VC-2. The TU terminating equipment 88 subsequently constructs the tributary unit group TUG-2, the TUG-2→VC-3 converter 86 converts the TUG-2 to the virtual container VC-3, the multiplexer (MUX) 84 multiplexes a plurality of virtual containers VC-3, the POH terminating equipment 83 adds a POH onto the virtual container VC-4, the SOH terminating equipment 82 adds on an STM-1 SOH and then the E/O 81₁ makes the conversion to an optical signal and sends the optical signal to a transmission path comprising an optical fiber bundle.

In a case where data from a high-speed terminal or extended ATM apparatus is transmitted, data from the high-speed terminal interface or extended ATM interface 91 is selected by the selector 92, the data is multiplexed by the multiplexer (MUX) 84, the POH of the virtual container VC-4 is added on by the POH terminating equipment 83, the STM-1 POH is added on by the SOH terminating equipment 82, the E/O 81₁ makes the conversion to an optical signal and sends the optical signal to a transmission path comprising an optical fiber bundle.

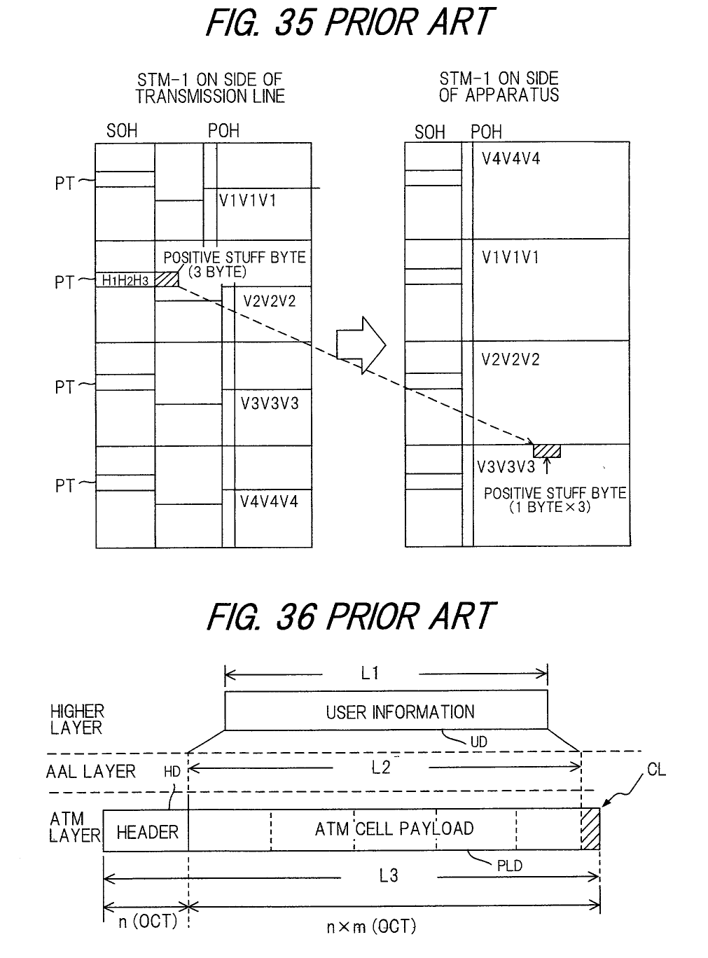

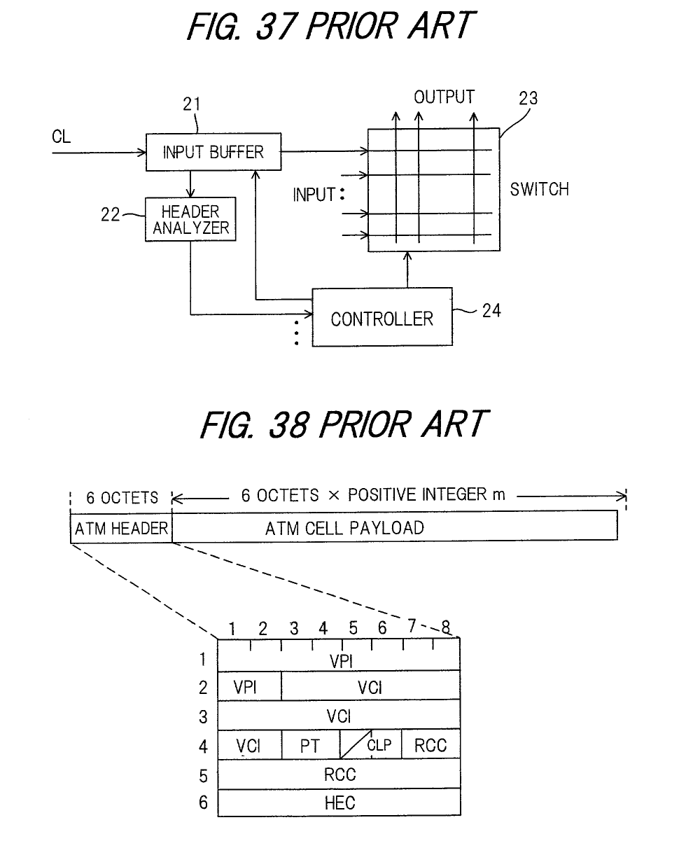

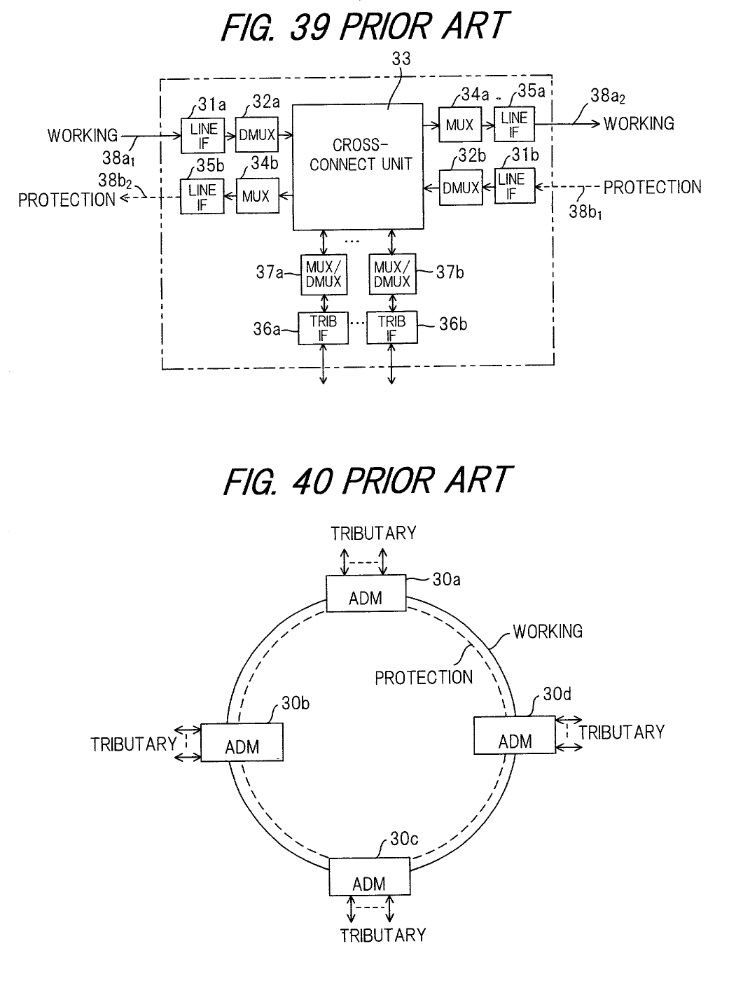

In a case where data is received from the transmission path, the O/E 81₂ converts the optical signal to an electric signal, the SOH terminating equipment 82 extracts the STM-1 SOH, and the POH terminating equipment 83 extracts the POH of the virtual container VC-4 and executes VC-4 stuff processing. The demultiplexer (DMUX) 85 subsequently demultiplexes the VC-4 to three VC-3s. In the case of data on the low-speed side, the VC-3→TUG-2 converter 87 converts the VC-3 to a TUG-2. The TU terminating equipment 88 effects separation into a VC-1 or VC-2 and positive stuffing or negative stuffing is performed in accordance with the stuffing processing decision made in the POH terminating equipment 83. The method of stuff processing is similar to that shown in FIG. 35. The cross-connect unit 89 performs cross connect in VC-1 or VC-2 units and then transmits the 6-, 2- and 1.5-MHZ data via the 6MIF 90₁, 2MIF 90₂ and 1.5MIF 90₃, respectively.

In a case where data is transmitted to a high-speed terminal or extended ATM apparatus, the data that has been demultiplexed by the demultiplexer (DMUX) 85 is sent to the high-speed terminal or extended ATM apparatus via the high-speed terminal interface or extended ATM interface 91. At this time positive stuffing or negative stuffing is performed in accordance with the stuffing processing decision made in the POH terminating equipment 83. The method of stuff processing is similar to that shown in FIG. 35. The monitor/controller 93 collects the SOH from the SOH terminating equipment 82 and the POH from the POH terminating equipment 83. The selector 94 performs loopback in STM-1 units by switching over the selected input to the side of O/E 81₂.

(F) Protection at Occurrence of Failure

(a) Network Configuration

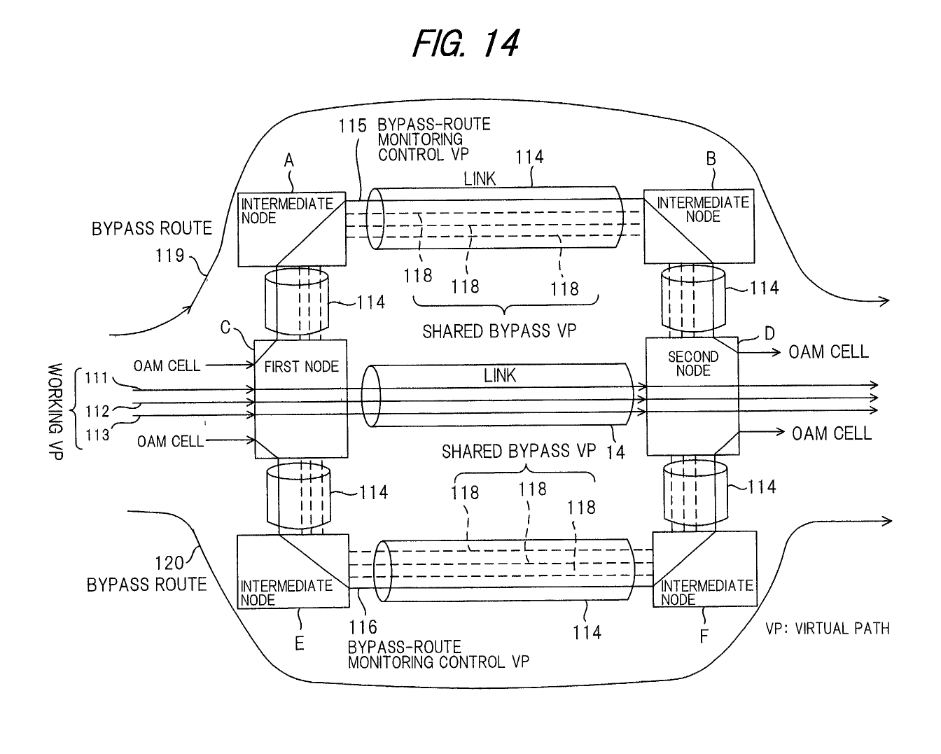

FIG. 14 is a diagram showing the configuration of a network useful in describing protection control at occurrence of a failure. Transmission apparatus (nodes) are indicated at A to F in FIG. 14, and the nodes are connected by links 114 comprising optical fiber or the like. The link 114 connecting nodes C and D accommodates working virtual paths 111, 112, 113.

One bypass-route monitoring control virtual path (bypass-route monitoring control VP) 115 has been set in a bypass route 119 that traverses nodes A and B, and one bypass-route monitoring control VP 116 has been set in a bypass route 120 that traverses nodes E and F. Further, each link constructing a bypass route is capable of accommodating a plurality of shared bypass VPs 118 indicated by the dashed lines. It should be noted that VP stands for “Virtual Path”.

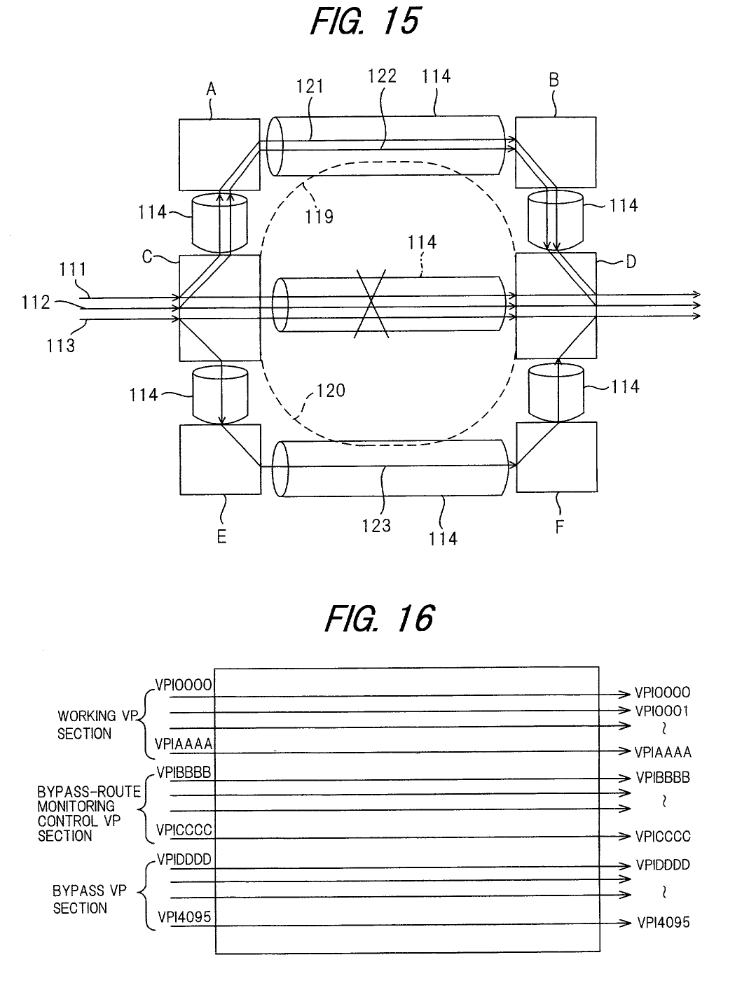

The bypass-route monitoring control VPs 115, 116 are set up in the bypass routes 119, 120, which are provided by pre-design as indicated by the dashed lines in FIG. 15. The pre-design assumes single failure of a link and preliminarily sets up a virtual path capable of dealing with link failures throughout the entire network. To deal with failure of the link (indicated by the × mark) that connects nodes C and D in the example of FIG. 15, virtual paths 121, 122 of the bypass route 119 traversing nodes A, B are assigned to the working virtual paths 111, 112, respectively, and a virtual path 123 of the bypass route 120 traversing nodes E, F is assigned to the working virtual path 113. The shared bypass VPs 118 indicated by the dashed lines in FIG. 14 are not bypass VPs solely of the bypass routes 119, 120 but are bypass VPs shared by a plurality of other bypass routes that traverse the link 114.

It should be noted that VPIs (Virtual Path Identifiers) are assigned in order to set up the bypass-route monitoring control VPs 115, 116 and bypass VPs in each of the links. It is required that the operating system (not shown) create VPI conversion tables (premaps) and distribute the VPI conversion tables to each of the nodes A to F in order to make VPI assignment possible.

If the entire area of the VPIs is 12 bits, the VPIs are managed by dividing the entire area (VPI 0000 to VPI 4095) into three sections, namely a working VP section, bypass-route monitoring control VP section and bypass VP section, as shown in FIG. 16. Available VPIs in these sections are successively assigned to the links. However, VPIs in the bypass VP section are assigned redundantly because all of the bypass VPs which use reserve bands of the links are shared.

(b) VPI Conversion Tables

Creation/Distribution of VPI Conversion Tables

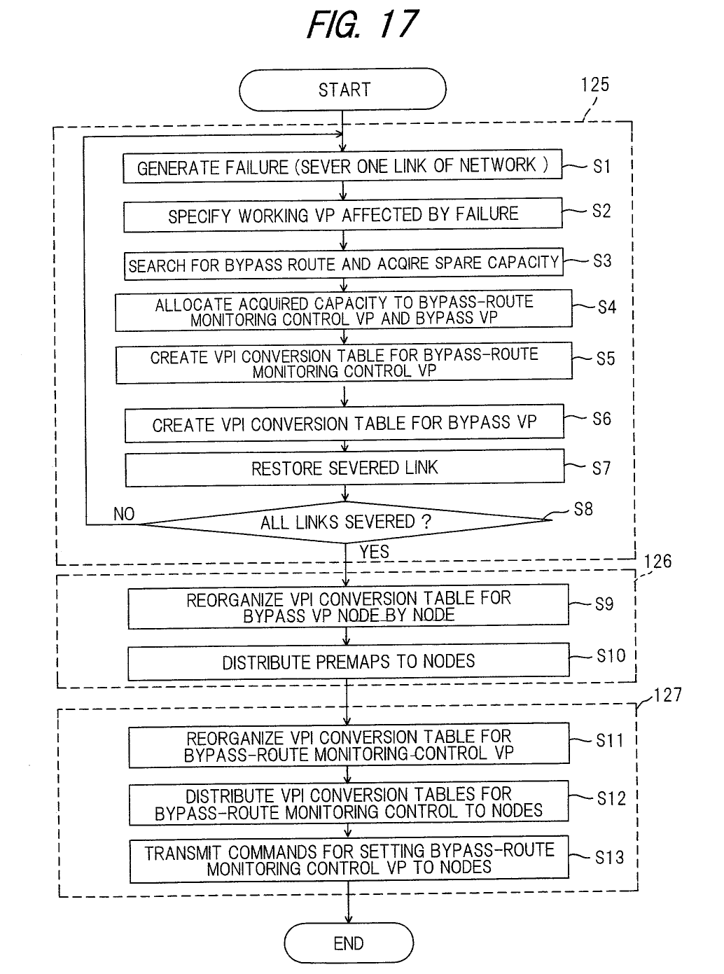

Reference will be had to the flowchart of FIG. 17 to describe a method of setting a VPI conversion table (premap) for each node. In FIG. 17, a block 125 indicates preliminary design of a VPI conversion table, a block 126 indicates the setting of a VPI conversion table in each node, and a block 127 indicates the setting of a bypass-route monitoring control VP. A VPI conversion table at the time of normal communication is created when the protection VP is set up.

First, at step S1 in FIG. 17, computer simulation is used to produce a failure by severing one of the links of the network.

Next, the working VP affected by the failure is specified at step S2 and a bypass route is found at step S3 to acquire spare capacity for the link. The spare capacity acquired is allocated to the bypass-route monitoring control VP and bypass VP at step S4.

A VPI conversion table for the bypass-route monitoring control VP is created at step S5 and a VPI conversion table for the bypass VP is created at step S6. A VPI conversion table at the time of normal communication is created when the protection VP is set up.

The severed link is restored at step S7 and it is determined at step S8 whether all links in the network have been severed and steps S1 to S7 executed. If the decision rendered at step S8 is “NO”, then steps S1 to S7 are executed again. If a “YES” decision is rendered at step S8, then control proceeds to step S9 and a VPI conversion table for a bypass VP is reorganized on a per-node basis.

A VPI conversion table for a different bypass VP is reorganized for each node at step S9. Next, the reorganized VPI conversion tables are distributed to the nodes at step S10.

Control then proceeds to step S11, at which a VPI conversion table for a bypass-route monitoring control VP is reorganized on a per-node basis. The VPI conversion tables for bypass-route monitoring control VPs thus reorganized are distributed to the nodes at step S12. Next, commands for setting bypass-route monitoring control VPs are transmitted to the nodes at step S13. As a result, one bypass-route monitoring control VP is set for each bypass route.

Example of VPI Conversion Table

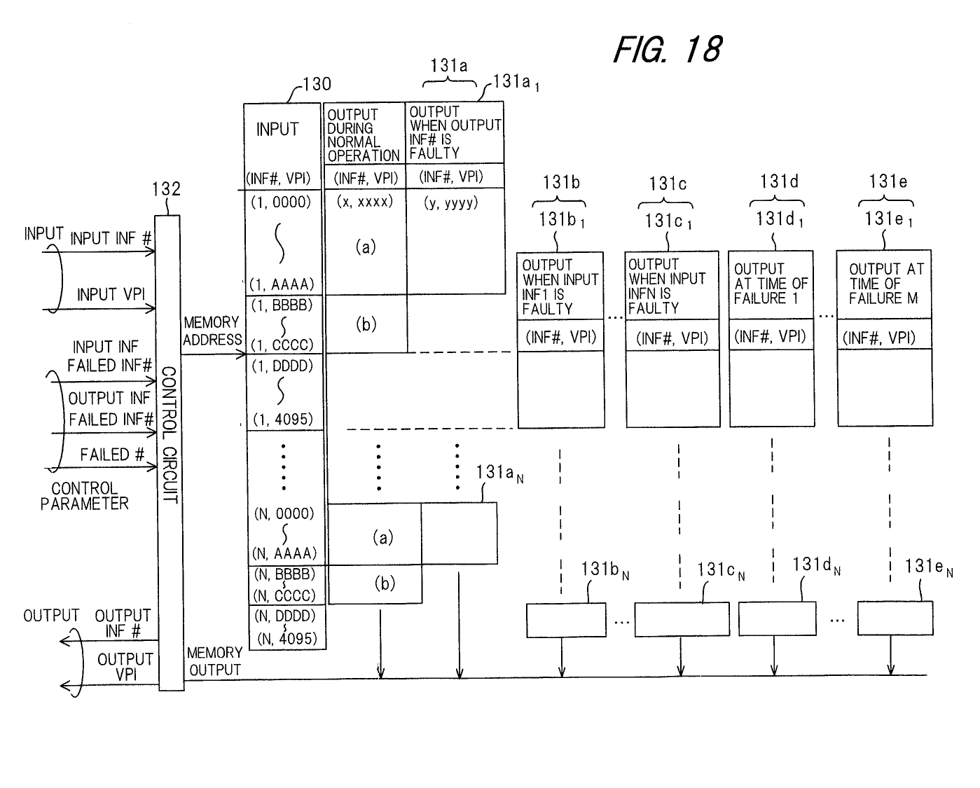

An example of a VPI conversion table will be described with reference to FIG. 18.

Numeral 130 in FIG. 18 denotes a first VPI conversion table for converting and outputting the VPI of a cell that enters at the time of normal communication. If it is assumed that there are N-number of input interfaces, input VPIs of 0 to 4095 are assigned to each of the interface numbers. With regard to each input interface number, addresses of “0” to “AAAA” are assigned to the working virtual paths; addresses of “BBBB” to “CCCC” are assigned to the bypass-route monitoring control virtual paths; and addresses of “DDDD” to “4095” are assigned to the bypass virtual paths. Input interface numbers and input VPIs are input to the first VPI conversion circuit 130 via a control circuit 132.

At the time of normal communication, the cell on a working virtual path is converted to an output interface number and VPI indicated in area (a), and these are output via the control circuit 132. Further, a cell on a bypass-route monitoring control virtual path is converted to an output interface number and VPI indicated in area (b), and these are output via the control circuit 132. Second VPI conversion tables 131a to 131e, which are for dealing with individual failures in the network, convert VPIs of entered cells to respective VPIs for bypass virtual paths. When a failure occurs, one of the second VPI conversion tables 131a to 131e is used in conformity with the failure to convert the VPI, which is then output from the selected output interface number. Shown at 131a₁ to 131a_{N} are VPI conversion tables for when output interfaces fail and for when links connected to these output interfaces fail. When an output interface number in area (a) agrees with an output interface number of an output interface that has failed, the content of the VPI conversion table 131a is read out.

Shown at 131b₁ to 131b_{N} are second VPI conversion tables for when an input interface #1 or link connected thereto fails. These tables are provided in correspondence with interfaces #1 to #N to which respective cells are input. Shown at 131c₁ to 131c_{N} are second VPI conversion tables for when an input interface #N or link connected thereto fails. These tables are provided in correspondence with the interfaces #1 to #N to which respective cells are input. Shown at 131d₁ to 131d_{N} are second VPI conversion tables for when a failure 1 occurs in the network at a point other than an input interface or output interface. Shown at 131e₁ to 131e_{N} are second VPI conversion tables for when a failure M occurs. These tables are provided in correspondence with respective ones of the input interfaces #1 to #N. When a failure occurs in an input interface, the content of the second VPI conversion table 131b or 131c is read out in accordance with the type of failure and the content is output via the control circuit 132. More specifically, the VPI of an entered cell is converted to a VPI for a bypass virtual path and the VPI is output via the selected output interface number. At the time of a failure other than a failure in an input/output interface and in the links connected to these interfaces, i.e., when another link in the network is severed, the content of the second VPI conversion table 131d or 131e is read out in accordance with the type of failure and the content is output via the control circuit 132. More specifically, the VPI of an entered cell is converted to a VPI for a bypass virtual path and the VPI is output via the selected output interface number. For the sake of explanation, the two VPI conversion tables 131b, 131c for failures in input interfaces are illustrated for each input interface number, and the two VPI conversion tables 131d, 131e for other failures are illustrated for each input interface number. In actuality, however, the numbers of these tables are N and M, respectively, in accordance with the types of failures.

Control at Time of Failure

With reference again to FIG. 14, OAM cells flow into the bypass-route monitoring control VPs 115, 116, whereby the state of the bypass route is monitored. When operation is normal, this monitoring is performed owing to flow of the OAM cells into the bypass-route monitoring control VPs 115, 116 periodically from the starting node C to the node D of the bypass route.

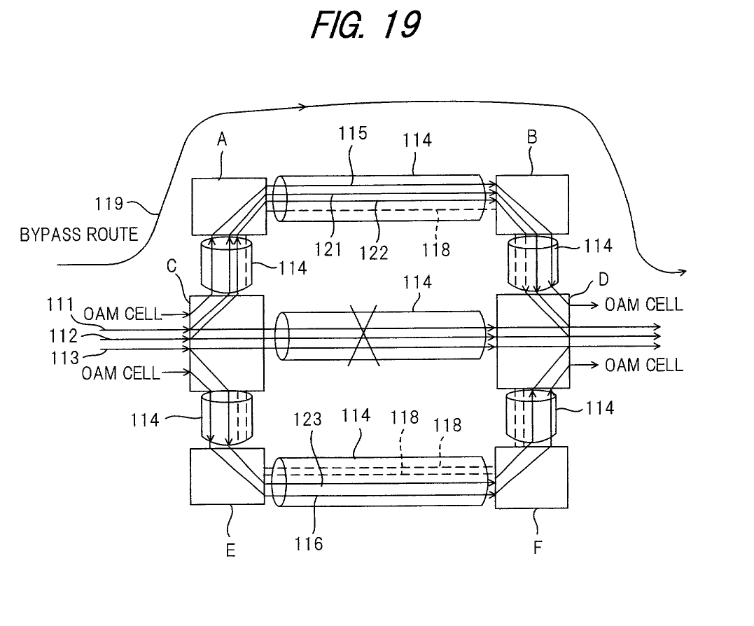

If a failure occurs, on the other hand, such as a failure in link 114 connecting nodes C and D, as indicated by the × mark in FIG. 19, the node D detects the failure and issues a remote alarm to the node C. The alerted node C passes OAM cells into the bypass-route monitoring control VPs 115, 116 and instructs the nodes A, B, E, F traversed by the virtual paths 115, 116 to change over their VPI conversion tables.

When these nodes A, B, E, F detect the OAM cells, they convert the VPI conversion table used to the first VPI conversion circuit 130 shown in FIG. 18 to any of the second VPI conversion tables 131a to 131e that corresponds to the failure reported by the OAM cell. As a result, the VPI of the input cell is converted to a VPI for a bypass VP, the VPI is output from the output interface, the bypass virtual paths VPs 121, 122 are set for the bypass route that traverses the nodes A, B, and the bypass virtual path VP 123 is set for the bypass route that traverses the nodes E, F.

If a bypass route is abnormal, the changeover of the VPI conversion table is aborted and the operating system is notified of the abnormality. The operating system so notified then sets another bypass route to deal with the link failure.

Operation in case of failure in a single link is described above. If failures occur in multiple links of the network, the possibility arises that reserve bands of links that failure simultaneously will be used as bypass routes. In this case, since the links accommodate a plurality of bypass-route monitoring control virtual paths, OAM cells that specify changeover of VPI conversion tables flow into these plurality of bypass-route monitoring control virtual paths. A node which this OAM cell traverses detects the OAM cell and notifies the operating system of an abnormality. If such contention for a bypass virtual route occurs, the operating system performs arbitration and re-establishes the bypass route.

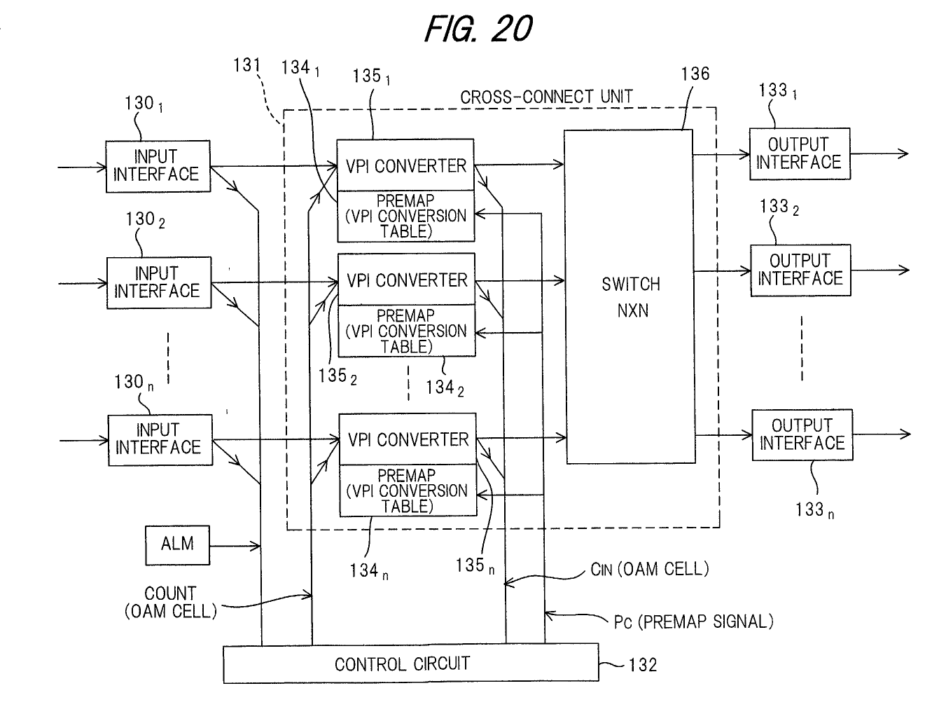

The configuration of a system for changing over a VPI conversion table will be described with reference to FIG. 20. The system for changing over a VPI conversion table shown in FIG. 20 is provided for each of the nodes A to F. The system includes input interfaces 130₁, 130₂, . . . , 130ₙ connected to n-number of input ports (not shown) to which cells are applied; a cross-connect unit 131; a controller 132; and output interfaces 133₁, 133₂, . . . , 133ₙ from which cells are output. The cross-connect unit 131 includes VPI converters 135₁, 135₂, . . . 135ₙ having VPI conversion tables 134₁, 134₂, . . . 134ₙ, respectively; and an N×N switch 136 having N signal lines vertically and horizontally for changing the routes of cells, which are supplied by the VPI converters 135₁, 135₂, . . . 135ₙ, and outputting the cells to the output interfaces 133₁, 133₂, . . . , 133ₙ. The input interfaces 130₁, 130₂, . . . , 130ₙ output cells, which have been input to the input ports, to the VPI converters 135₁, 135₂, . . . , 135ₙ and output an alarm to the controller 132 when occurrence of a failure has been detected. The VPI converters 135₁, 135₂, . . . 135ₙ separate OAM cells CIN from the cells supplied by the input interfaces 130₁, 130₂, . . . , 130ₙ, output these OAM cells to the controller 132, multiplex OAM cells COUT, which are output from the controller 132, onto a main signal (information cell) and output the resulting signal to the switch 136. When the controller 132 detects the occurrence of failure from the alarm ALM and changeover of the VPI conversion tables (premaps) 134₁ to 134ₙ is instructed by OAM cells, the controller 132 outputs a premap control signal PC to the VPI converters 135₁, 135₂, . . . 135ₙ to thereby change over the VPI conversion tables 134₁ to 134ₙ.

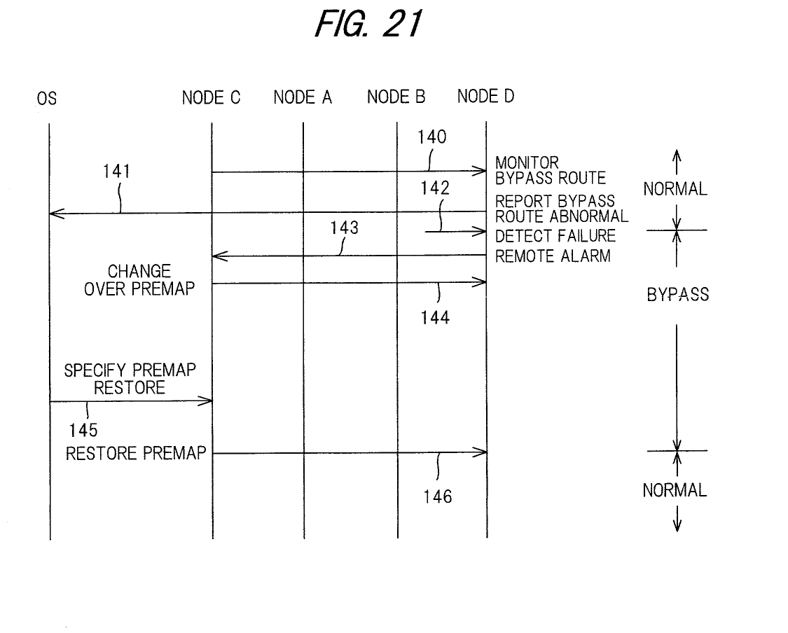

The operation sequence of the communication network set forth above will be described with reference to FIG. 21. The bypass route will be limited to the one traversing the nodes A and B. During normal operation, the node C transmits an OAM cell (normal) to the bypass-route monitoring control VP 115 in the direction of node D, as indicated arrow 140 in FIG. 21, at a long period that will not occupy the band of the link. If the bypass route 119 is abnormal at this time, the node D so notifies the operating system OS, as indicated by arrow 141. For example, if the link 114 connecting the nodes C and D develops a failure, as indicated by the × mark in FIG. 19, the node D detects the failure and sends a remote alarm to the node C on the failed end upstream, as indicated by arrow 142. In order for the alerted node C to instruct changeover of the VPI conversion table to the bypass route traversing the nodes A and B, it transmits an OAM cell (which specifies premap changeover) to the bypass-route monitoring control VP 115 at a short period, as indicated by arrow 144. The nodes A and B implement the changeover of the VPI conversion table (premap) if this OAM cell passes through j times. As a result, bypass virtual paths 121, 122 are set up in the bypass route traversing nodes A and B.

When recovery from the failure is achieved, the operating system OS transmits a premap restore command to the node C on the failure end, as indicated by arrow 145. In order for the node C to respond by restoring the VPI conversion table to the normal state, it transmits an OAM cell (premap restoration) to the node D at a short period via the bypass-route monitoring control VP 115, as indicated by arrow 146. After this OAM cell has passed through k times, the nodes A and B restore the VPI conversion table to the normal state and open the connections of bypass virtual paths 121, 122. The transmission period of the OAM cells and the numbers j, k of detection protection cycles are set taking communication quality into consideration.

(G) Add/Drop Multiplexer (ADM)

(a) Network Configuration

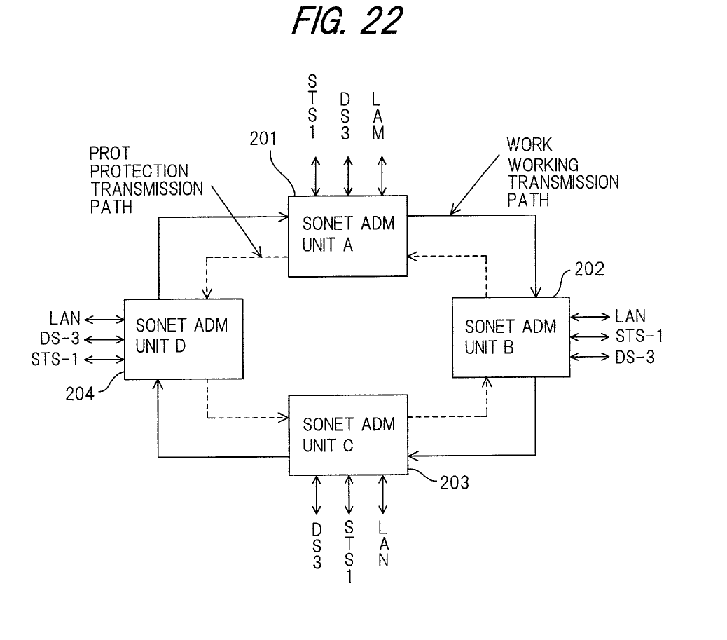

A SONET ADM unit will be described as a specific example of an ADM unit according to the present invention. FIG. 22 is a schematic view showing the configuration of a network to which a SONET ADM unit is applied. Optical fiber of the communication protocol OC-3 (155.52 M) is used as the transmission path and four SONET ADM units A to D (201 to 204) are connected by this optical fiber to form a ring topology. The optical fiber includes a working optical fiber WORK and a protection optical fiber PROT. The transmission direction of the working optical fiber WORK is opposite that of the protection optical fiber PROT. Each of the SONET ADM units A to D (201 to 204) sends and receives signals using the working optical fiber during normal operation and sends and receives signals using the protection optical fiber when a failure occurs. A private branch exchange (referred to as a LAN below), in addition to a DS-3 (Digital Signal Level 3) communication network and an STS-1 (Synchronous Transport Signal Level 1) communication network, is connected to the SONET ADM units A to D (201 to 204).

(b) Internal Structure of SONET ADM Unit

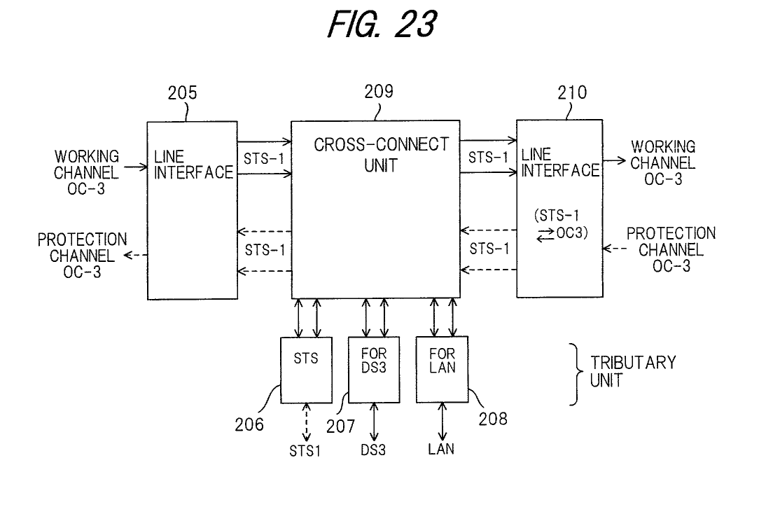

FIG. 23 is a diagram showing the internal structure of the SONET ADM unit A (201). The SONET ADM unit A (201) includes a cross-connect unit 209 and line interfaces 205, 210 provided at the connections between the cross-connect unit 209 and optical fiber. In FIG. 23, the input section of the working optical fiber (the output section of the protection optical fiber) of the cross-connect unit 209 is equipped with a line interface 205, and the output section of the working optical fiber (the input section of the protection optical fiber) is equipped with a line interface 210. Here it is assumed that the line interfaces 205, 210 and the cross-connect unit 209 are connected by a signal line at the STS-1 level. The line interfaces 205, 210 convert OC-3 signals, which have been received from the working and protection optical fibers, to STS-1 signals and input these signals to the cross-connect unit 209. Further, the line interfaces 205, 210 convert STS-1 signals, which have been output from the cross-connect unit 209, to OC-3 signals and send these signals to the optical fibers. Furthermore, the SONET ADM unit A (201) is provided with a DS3 tributary interface 207 at the connection between the cross-connect unit 209 and DS3 line. Further, the connection between the cross-connect unit 209 and STS-1 line is provided with an STS-1 tributary interface 206, and the connection between the cross-connect unit 209 and LAN is provided with a LAN tributary interface 208.

(c) DS3 Tributary Interface

By way of example, the DS3 tributary interface 207 is constituted by a selector, an STS terminator and a line terminator, though these are not shown. With regard to signal transmission, the selector switches between transmission to the working optical fiber and transmission to the protection optical fiber. With regard to signal reception, the selector switches between accepting a signal from the working optical fiber and accepting a signal from the protection optical fiber. The STS terminator terminates an STS-1 signal output from the selector and converts the signal to a signal in the DS3 format. The STS terminator further converts a DS3-format signal, which has been received by the line terminator, to a signal in the STS-1 format and transfers this signal to the selector. The line terminator sends and receives signals to and from the DS3 communication line.

(d) STS Tributary Interface

The STS-1 tributary interface 206 is constituted by a selector and a line terminator. With regard to signal transmission, the selector switches between transmission to the working optical fiber and transmission to the protection optical fiber. With regard to signal reception, the selector switches between accepting a signal from the working optical fiber and accepting a signal from the protection optical fiber. The line terminator transmits an STS-1 signal, which has been output from the selector, to the STS-1 communication line, and transfers an STS-1 signal, which has been received from the STS-1 communication line, to the selector.

(e) LAN tributary interface

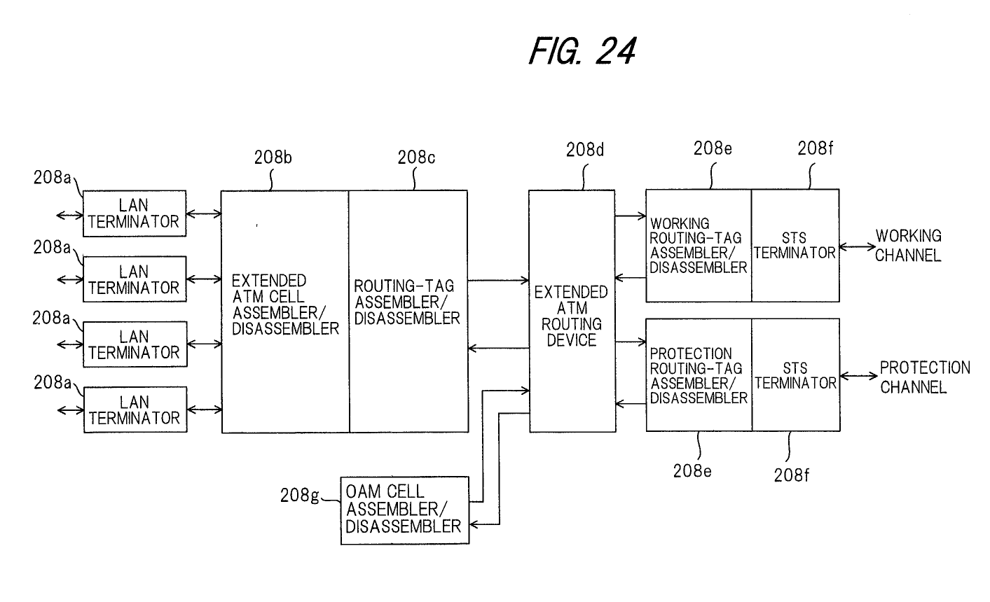

As shown in FIG. 24, the LAN tributary interface 208 is obtained by connecting a plurality of LAN communication lines, each connection of which is provided with a LAN terminator 208a. With regard to signal transmission, an extended ATM cell assembler/disassembler 208b converts a signal, which has been received from the LAN terminator 208a, to an extended ATM cell. With regard to signal reception, the extended ATM cell assembler/disassembler 208b disassembles an extended ATM cell, which has been received from a routing-tag assembler/disassembler 208c, and generates a LAN-compatible signal.

With regard to signal transmission, the routing-tag assembler/disassembler 208c adds a routing tag onto the extended ATM cell generated by the extended ATM cell assembler/disassembler 208b. The routing tag, which is decided based upon the destination of the extended ATM cell and SONET failure information, is information specifying transmission to the working optical fiber or transmission to the protection optical fiber. Further, the routing-tag assembler/disassembler 208c removes a routing tag that has been added onto an extended ATM cell that enters at the time of reception.

If a received signal is not an OAM cell, routing-tag assembler/disassemblers 208e, 208e′ on the side of the cross-connect add on a routing tag specifying the LAN that is the destination of the signal. Of these two routing-tag assembler/disassemblers 208e, 208e′, the routing-tag assembler/disassembler 208e on the working side adds on a routing tag specifying the destination LAN, while the routing-tag assembler/disassembler 208e′ on the protection side adds on a routing tag specifying discarding a signal. With regard to signal transmission, when extended ATM signals are received from the routing-tag assembler/disassemblers 208e, 208e′, STS terminators 208f, 208f′ disassemble these ATM signals, convert them to signals of the STS-1 format and output them to the transmission paths. Further, the STS terminators 208f, 208f′ convert signals of the STS-1 format received from the transmission paths to extended ATM cells. An OAM cell assembler/disassembler 208g generates an OAM cell, which contains failure occurrence information, if an abnormality has occurred in a received extended ATM cell (i.e., if the extended ATM cell has not been synchronized correctly). In a case where an OAM cell containing failure occurrence information has been received from another SONET ADM unit, the CPU (not shown) within this unit decodes this OAM cell into one having a processable data format.

(f) Extended ATM Protection Function

Application Program Execution Function

The extended ATM protection function of the SONET ADM unit A (201) will now be described.

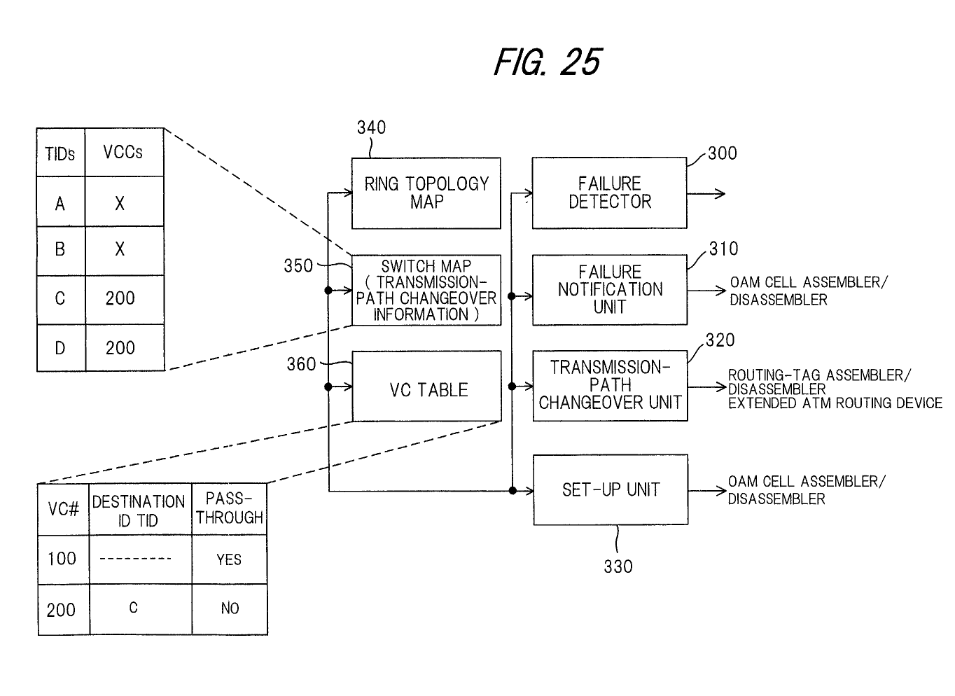

FIG. 25 illustrates a block diagram the functions of which are implemented by having the CPU of the SONET ADM unit A (201) execute an application program stored in memory. A failure detector 300 monitors extended ATM cells received by the LAN tributary interface 208 and detects poor synchronization of extended ATM cells. Upon detecting poor synchronization of an extended ATM cell, the failure detector 300 judges that a failure has occurred in whichever of the neighboring SONET ADM units is situated upstream or in the optical fiber connected to this SONET ADM unit.

When the failure detector 300 detects the occurrence of a failure, the failure notification unit 310 notifies the other SONET ADM units that the failure occurred. More specifically, if the failure detector 300 detects that a failure has occurred in the neighboring SONET ADM unit that is upstream, the failure notification unit 310 notifies the OAM cell assembler/disassembler 208g of the TID (Terminal Identification) of this SONET ADM unit and notifies the other SONET ADM units. At this time the OAM cell assembler/disassembler 208g generates an OAM cell for failure information and an OAM cell for a protection switch and inserts these into the management channel of the optical fiber. Available as the OAM cell for failure information are an OAM cell containing an alarm indication signal AIS transmitted to the downstream side of the working optical fiber, and an OAM cell containing a far-end receive failure signal transmitted to the upstream side of the working optical fiber.

OAM Cell

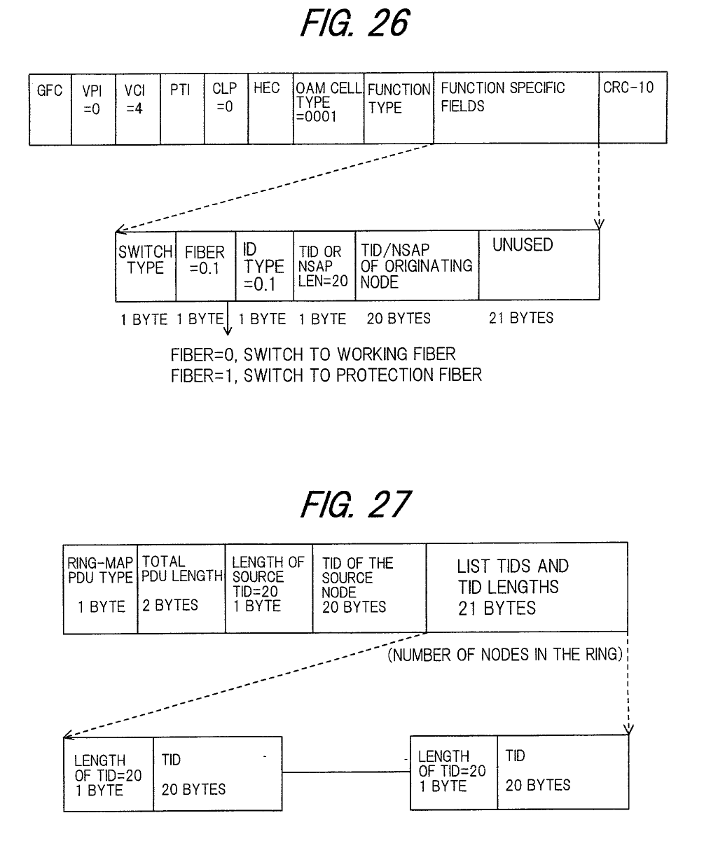

The OAM cell for the protection switch stores the type of protection switch in a function-specific field, as shown in FIG. 26. The function-specific field is composed of (1) switch type; (2) fiber ID type, which stores information (working optical fiber or protection optical fiber) specifying an optical fiber in which a failure has occurred; (3) TID or NSPA length; (4) TID/NSAP of originating node; and (5) an unused area. If a failure has occurred in the signal transmission path from the SONET ADM unit of the communicating party to its own node, a transmission-path changeover unit 320 switches the signal reception path from the working to the protection channel.

VC Table

As shown in FIG. 25, a VC table 360 stores destination TID information and pass-through identification information for every channel that has been multiplexed onto optical fiber of the OC-3 level. The destination TID information is information for identifying the destination SONET ADM unit using the particular channel. For example, if channels “100” and “200” have been multiplexed onto the optical fiber of the OC-3 level and the SONET ADM unit A (201) and SONET ADM unit C (203) are communicating using channel “200”, nothing is registered in the VC table 360 of the SONET ADM unit A (201) as the destination TID information of channel “100” and “YES” is registered as the pass-through identification information of this channel. On the other hand, “C” is registered as the destination TID information of channel “200” in VC table 360 and “NO” is registered as the pass-through identification information of this channel.

Ring Topology Map

A ring topology map 340 indicates the transmission path topology of the SONET working optical fiber. For example, in FIG. 22, the transmission direction of the working optical fiber WORK is SONET ADM unit A (201)→SONET ADM unit B (202)→SONET ADM unit C (203)→SONET ADM unit D (204)→SONET ADM unit A (201) and therefore “B→C→D” is recorded as the ring topology map of the SONET ADM unit A (201). Further, “C→D→A” is recorded as the ring topology map of the SONET ADM unit B (202), “D→A→B” as the ring topology map of the SONET ADM unit C (203) and “A→B→C” as the ring topology map of the SONET ADM unit D (204). This topology is established when the ring topology map of the SONET is set up. The topology is established by causing a protocol data unit referred to as a “ring map PDU” to circulate through a management channel reserved in the optical fiber.

As shown in FIG. 27, the ring map PDU is composed of (1) an information area (Ring-map PDU type) indicating the type of protocol data unit; (2) an information area (Total PDU length) indicating the length of the protocol data unit; (3) a source-identification information area (TID of source node) for identifying the SONET ADM unit that is the source of the protocol data unit; (4) an information area (Length of source TID) indicating the length of the source-identification information area; and (5) a SONET ADM unit list area (List TIDs and TID lengths) indicating a list of SONET ADM units residing on the optical fiber of OC-3 level. Registered in the SONET ADM unit list area are a unit-identification information area (TID) of each SONET ADM unit and a length area (Length of TID) indicating the length of the unit-identification information area (TID). When the ring map PDU is transmitted, the source SONET ADM unit writes its own SONET ADM unit identification information (TID) in the source-identification information area (TID of source node) of the ring map PDU and writes the length of the unit-identification information (TID) in the length information area (Length of TID). The source SONET ADM unit inserts the ring map PDU into the multiplexed channel of the optical fiber and transmits it over the SONET. Upon receiving the ring map PDU, another SONET ADM unit writes its own SONET ADM unit identification information (TID) to the tail end of the SONET ADM unit list area (List TIDs and TID lengths) and inserts it into the management channel. Thus, the ring map PDU is sent back to the source SONET ADM unit via a plurality of SONET ADM units on the SONET. Upon receiving the ring map PDU issued from its own node, the source SONET ADM unit generates the ring topology map 340 in accordance with the list information of the SONET ADM unit list area (List TIDs and TID lengths).

This processing is executed by a set-up unit 330 when the SONET is set up, when a new node is added on or at regular time intervals.

Switch Map

If a failure develops the optical fiber, a switch map 350 stores information for switching between the working and protection channels. A specific example is illustrated in FIG. 25. The illustrated switch map is that of the SONET ADM unit A (201) and corresponds to the VC table 360 in FIG. 25.

Transmission-path changeover information (VCCS) are stored in the switch map 350 for every TID (Terminal ID) of SONET ADM units residing on the SONET. If a failure has occurred in a SONET ADM unit, the transmission-path changeover information (VCCS) identifies whether the signal transmission path from the communicating party to the node of this SONET ADM unit will be severed. It is so arranged that the channel used between the node of this SONET ADM unit and the SONET ADM unit of the communicating party is registered as transmission-path changeover information in the SONET ADM unit whose signal transmission path will be severed.

By way of example, if the SONET ADM unit A (201) is communicating with the SONET ADM unit C (203) using the channel “200”, then the SONET ADM unit C (203) and SONET ADM unit D (204) exist on the signal transmission path from the SONET ADM unit C (203) to the SONET ADM unit A (201). If a failure occurs in the SONET ADM unit C (203) or SONET ADM unit D (204), therefore, the signal transmission path from the SONET ADM unit C (203) to the SONET ADM unit A (201) will be severed and it will be necessary to switch the signal transmission path. Accordingly, channel value “200” is registered in the column of the transmission-path changeover information of SONET ADM unit C (203) and SONET ADM unit D (204) in switch map 350. Nothing is registered in the column of the transmission-path changeover information of SONET ADM units other than SONET ADM unit C (203) and SONET ADM unit D (204).

When notification of occurrence of a failure has been given by an OAM cell, reference is had to the column of the transmission-path changeover information. If a channel value has been registered in the column of the faulty node, then a switch is made between the working and protection channels. This changeover of the transmission path is carried out by changing over the content of the routing tag to be added on by the routing-tag assembler/disassembler 308e of the working and protection channels. In other words, the content of the routing tag added on by the routing-tag assembler/disassembler 308e of the protection channel and the content of the routing tag added on by the routing-tag assembler/disassembler 308e of the working channel are interchanged.

Protection Operation

The actions and effects of this embodiment will now be described.

First, the ring topology map 340 is created.

When the set-up unit 330 receives a ring map PDU from the neighboring SONET ADM unit upstream upon issuing a ring map PDU, it determines whether the received ring map PDU was issued from its own node or from another SONET ADM unit. In other words, the set-up unit 330 reads the TID out of the source-identification information area (TID of source node) of the received ring map PDU and compares this TID with its own TID. If the two TIDs match, then the set-up unit 330 judges that this ring map PDU was transmitted from its own node, reads the list of TIDs out of the SONET ADM unit list area (List TIDs and TID lengths) of the ring map PDU and then discards this ring map PDU. Next, the SONET ADM unit creates the ring topology map 340 based upon the TID list that was read out of the ring map PDU.

Processing for creating the VC table 360 will be described next. This processing is executed in accordance with a command entered by the operator. That is, the operator of each SONET ADM unit enters all channels multiplexed onto the SONET, the SONET ADM unit identification information (TID) of the communicating party and the channel used between itself and the SONET ADM unit of the communicating party. The set-up unit 330 registers all channels in the VC table format. Next, on the basis of the channel used and the SONET ADM unit identification information (TID) of the communicating party, the set-up unit 330 writes the SONET ADM unit identification information (TID) of the communicating party to the destination information area of the channel used and writes “NO” to the pass-through identification information of the channel used. Furthermore, the setup unit 330 registers nothing in the destination information areas of channels other than the channel used and writes “YES” to the pass-through identification information areas of these channels.

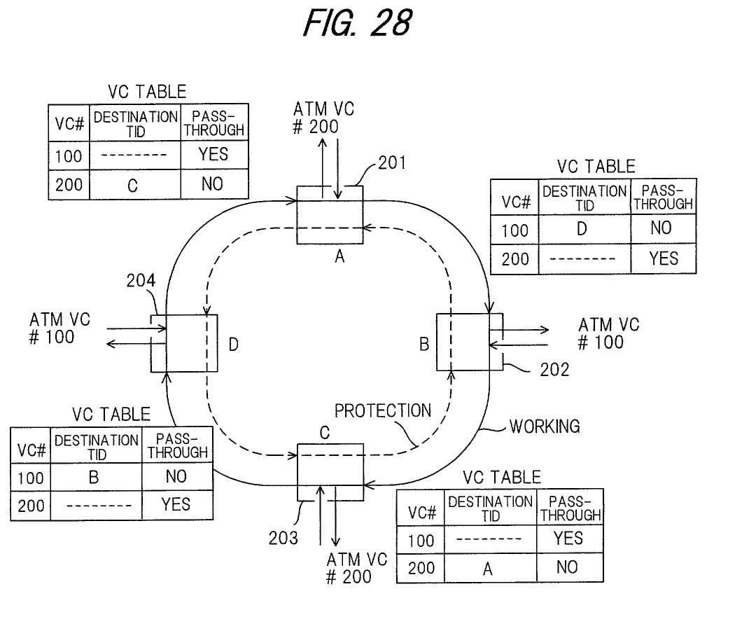

By way of example, if the SONET ADM unit (A) 201 and SONET ADM unit C (203) communicate using the channel “200” and the SONET ADM unit B (202) and SONET ADM unit (D) 204 communicate using the channel “100”, as shown in FIG. 28, then the TID “C” of SONET ADM unit C (203) is registered in the destination information area of channel “200” and “NO” is registered in the pass-through identification information area of channel “200” in the VC table of SONET ADM unit A (201), as illustrated. Further, the TID “D” of SONET ADM unit D (204) is registered in the destination information area of channel “100” and “NO” is registered in the pass-through identification information area of channel “100” in the VC table of SONET ADM unit B (202). VC tables of each of the nodes are created in similar fashion.

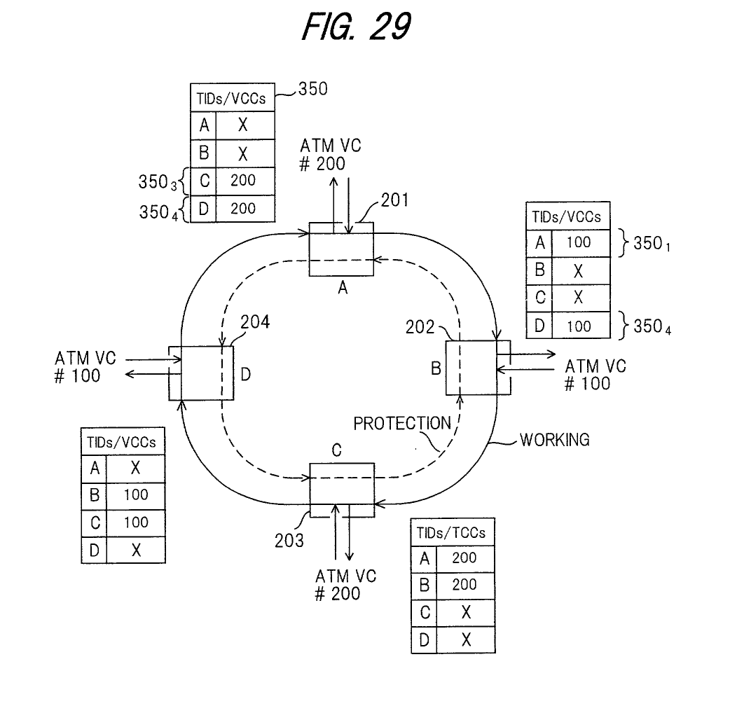

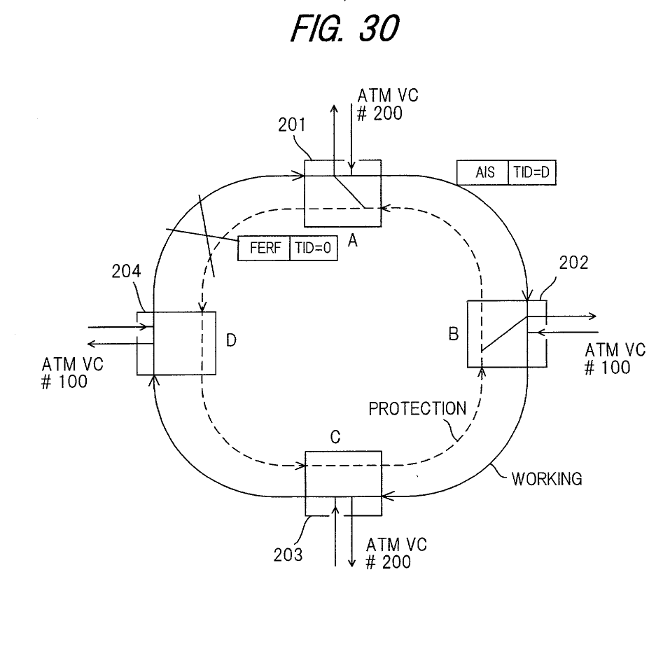

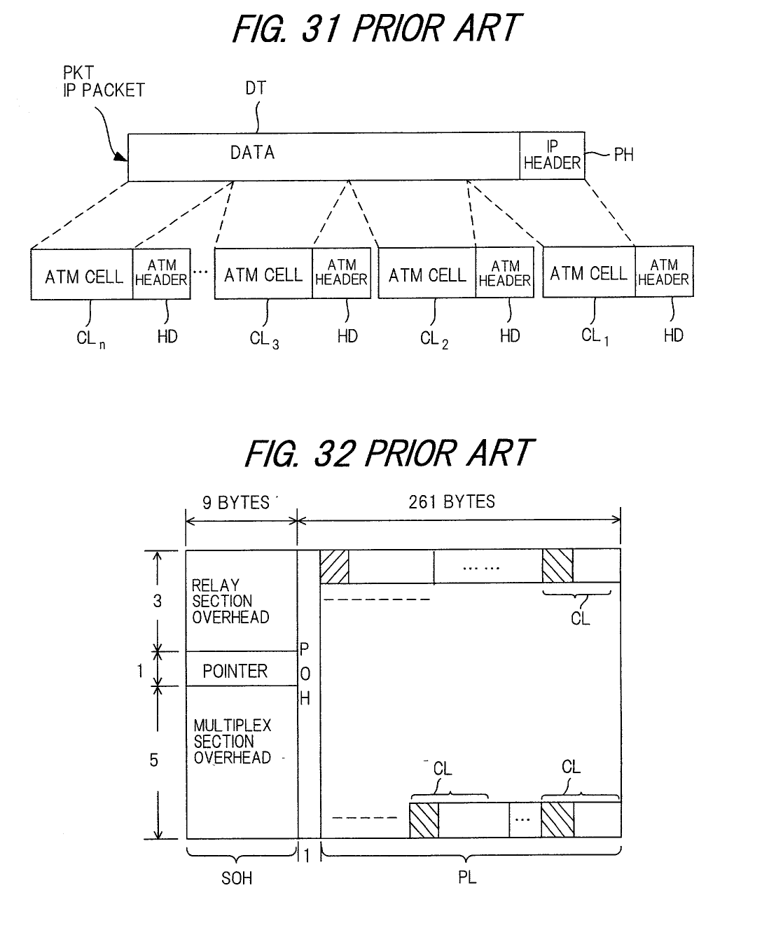

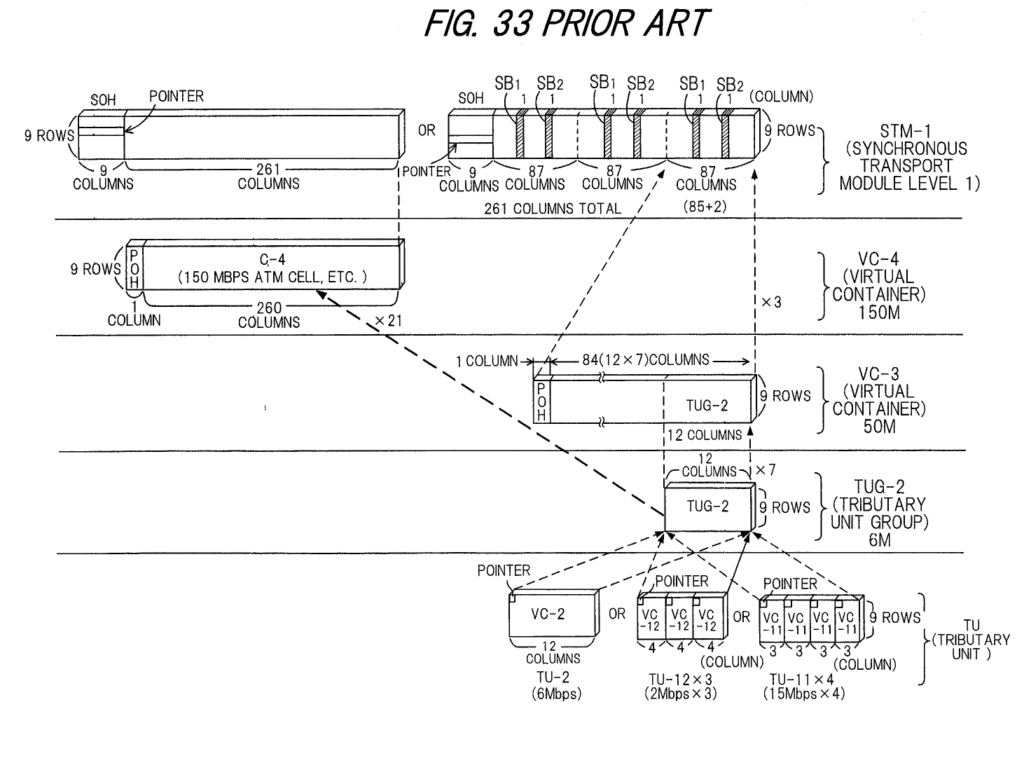

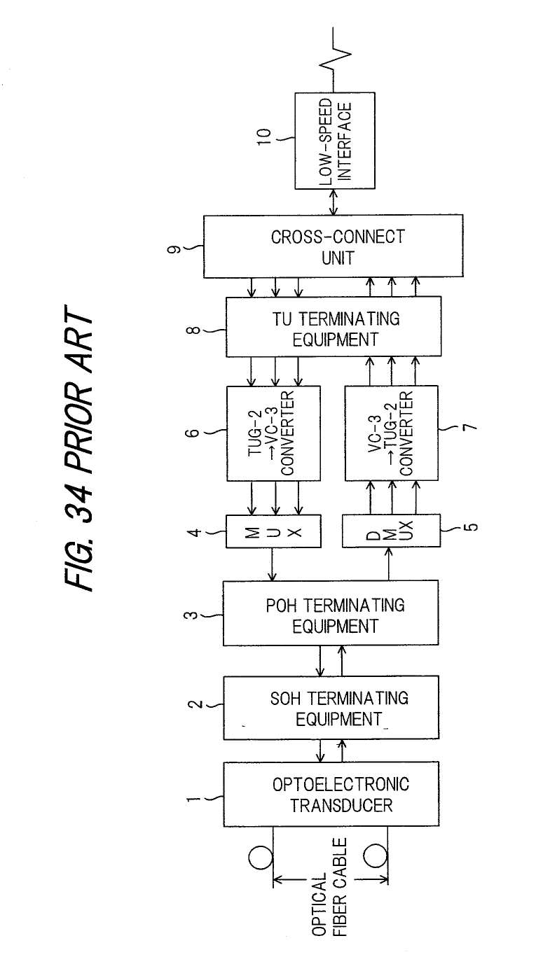

When the setting of the ring topology map 340 and VC table 360 ends, the set-up unit 330 creates the switch map 350 in the manner shown in FIG. 29. Specifically, the set-up unit 330 registers in the switch map 350 the TIDs of all SONET ADM units that reside on the SONET. Next, the set-up unit 330 registers a value “200” in a transmission-path changeover information column 350₃ of the ADM unit C and in a transmission-path changeover information column 350₄ of the ADM unit D in the switch map 350 of SONET ADM unit A (201). Further, the SONET ADM unit B (202) and SONET ADM unit (D) 204 communicate using the channel “100”. In this case, the SONET ADM unit D (204) and the SONET ADM unit A (201) reside on the signal transmission path from the SONET ADM unit D (204) to the SONET ADM unit B (202). The channel value “100” is registered in the switch map 350 of SONET ADM unit B (202) in a transmission-path changeover information column 350₄ of ADM unit D and a transmission-path changeover information column 350₁ of ADM unit A. Switch maps 350 of the SONET ADM unit C (203) and SONET ADM unit D (204) are created in similar fashion.

The operation of the SONET ADM unit at the time of ordinary communication will now be described. Communication processing relating to STS-1 and DS-3 need not be described as it is similar to that of the prior art.

Upon receiving signals from the working optical fiber WORK and protection optical fiber PROT, the SONET ADM unit converts the signals to signals of the STS-1 level in the line interfaces 205, 210 (FIG. 23) and then inputs these signals to the cross-connect unit 209. If a signal whose destination in the LAN enters, the control unit cross-connect 209 inputs this signal to the LAN tributary interface 208.

The routing-tag assembler/disassembler 208e (FIG. 24) on the working side of the LAN tributary interface 208 detects the VCI from the header of the extended ATM cell and identifies the channel used. The routing-tag assembler/disassembler 208e searches the VC table 360 using the detected channel as the key word and refers to the pass-through identification information.

On the other hand, the routing-tag assembler/disassembler 208e′ on the protection side extracts the VCI from the header of the extended ATM cell and identifies the channel used. The routing-tag assembler/disassembler 208e′ searches the VC table 360 using the detected channel as the key word and refers to the pass-through identification information.

If “YES” has been registered in the pass-through identification information, the protection routing-tag assembler/disassembler 208e′ assembles a routing tag with itself (the protection routing-tag assembler/disassembler 208e′) as the destination and adds this tag onto an extended ATM cell. If “NO” has been registered in the pass-through identification information of the VC table 360, the protection routing-tag assembler/disassembler 208e′ assembles a routing tag for discarding the extended ATM cell and adds this cell onto the extended ATM cell. Furthermore, in a case where a received extended ATM cell is an OAM cell, the routing-tag assembler/disassemblers 208e, 208e′ assemble routing tags with the OAM cell assembler/disassembler 208g as the destination and add the tags onto extended ATM cells.

If extended ATM cells enter from the two routing-tag assembler/disassemblers 208e, 208e′, an extended ATM routing device 208d refers to the routing tag of each extended ATM cell-and changes over the transport route. In the case of pass-through, the routing-tag assembler/disassemblers 208e, 208e′ remove the routing tags from the extended ATM cells that have returned and input cells to the STS terminators 208f, 208f′. The STS terminators 208f, 208f′ map the extended ATM cells that have entered from the routing-tag assembler/disassemblers 208e, 208e′ to STS-1 signals and send the signals to the transmission lines. The foregoing makes it possible for extended ATM cells to pass through.

If a destination LAN has been registered in the routing tag of an entered extended ATM cell, the extended ATM routing device 208d transfers this extended ATM cell to the routing-tag assembler/disassembler 208c. As a result, the extended ATM cell can be dropped. Furthermore, if discard command information has been registered in the routing tag of an entered extended ATM cell, the extended ATM routing device 208d discards the extended ATM cell. If information indicating the OAM cell assembler/disassembler 208g as the destination has been registered in the routing tag of an entered extended ATM cell, the extended ATM routing device 208d transfers this extended ATM cell to the OAM cell assembler/disassembler 208g.

In a case where the extended ATM routing device 208d has dropped an extended ATM cell, the routing-tag assembler/disassembler 208c removes the routing tag from the extended ATM cell that has entered from the extended ATM routing device 208d and inputs the cell to the extended ATM cell assembler/disassembler 208b. If an extended ATM cell enters from the routing-tag assembler/disassembler 208c, the extended ATM cell assembler/disassembler 208b disassembles this extended ATM cell and restores the cell to the signal format compatible with the LAN that is the destination. The extended ATM cell assembler/disassembler 208b then transfers the restored signal to the LAN terminator 208a of the destination LAN. Thus, an extended ATM cell can be handled just as in an STS-1 or DS-3 service implemented by a SONET in the prior art.

The operation of the SONET ADM unit A (201) when a failure occurs will now be described in accordance with FIG. 29.

If the failure detector 300 detects that a failure has occurred in the signal transmission line from the SONET ADM unit D (204), the failure notification unit 310 notifies the OAM cell assembler/disassembler 208g of the identification TID of the SONET ADM unit D (204) and transmits an OAM cell over the SONET. More specifically, the OAM cell assembler/disassembler 208g inserts an OAM cell, which contains the alarm indication signal AIS, into the management channel of the working optical fiber and transmits the cell to the downstream side [SONET ADM unit B (202)]. The OAM cell assembler/disassembler 208g inserts an OAM cell, which contains a receive failure signal FERF, into the management channel of the protection optical fiber and transmits the cell to the upstream side [SONET ADM unit D (204)]. Furthermore, the OAM cell assembler/disassembler 208g inserts a protection-switch OAM cell into the management channel of the working optical fiber and transmits the cell to the downstream side.

Upon receiving a failure information OAM cell and a protection-switch OAM cell, the routing-tag assembler/disassembler 208e of the LAN tributary interface 208 in the SONET ADM unit B (202) adds a routing cell whose destination is the OAM cell assembler/disassembler 208g onto this OAM cell, and the extended ATM routing device 208d transfers this OAM cell to the OAM cell assembler/disassembler 208g. The transmission-path changeover unit 320 is activated upon being notified of failure occurrence by the OAM cell. As a result, the transmission-path changeover unit 320 searches the switch map 350 (see FIG. 29) using the device ID (TID=“D”) indicative of the faulty location as the key word. Since “100” has been stored in the transmission-path changeover information column of the ADM unit D in switch map 350, the transmission-path changeover unit 320 instructs the routing-tag assembler/disassembler 208e′ on the protection side to change the content of the routing flag, thereby changing over the transmission path. In other words, the routing-tag assembler/disassembler 208e′ on the protection side adds a routing flag, which is the same as that of the routing-tag assembler/disassembler 208e on the working side, onto a subsequently received extended ATM cell. As a result, the SONET ADM unit B (202) drops the extended ATM cell from the SONET ADM unit D (204) from the optical fiber of the protection channel.

Further, upon receiving a failure information OAM cell and a protection-switch OAM cell, the SONET ADM unit C (203) activates the transmission-path changeover unit 320 in a manner similar to that of the SONET ADM unit B (202). The transmission-path changeover unit 320 searches the switch map 350 using the TID “D” indicative of the faulty location as the key word. Since nothing has been stored in the transmission-path changeover information column of the ADM unit D in switch map 350, the transmission path is not changed over.

Furthermore, upon receiving a failure information OAM cell and a protection-switch OAM cell, the SONET ADM unit D (204) activates the transmission-path changeover unit 320. The latter searches the switch map 350 using the TID “D” indicative of the faulty location as the key word. Since nothing has been stored in the transmission-path changeover information column of the ADM unit D in switch map 350, the transmission path is not changed over. Further, at the moment a failure occurs, the SONET ADM unit A (201) activates the transmission-path changeover unit 320 and searches the switch map 350 using the TID “D” indicative of the faulty location as the key word. Since “200” has been stored in the transmission-path changeover information column of the ADM unit D in switch map 350, the transmission-path changeover unit 320 instructs the routing-tag assembler/disassembler 208e′ on the protection side to change the content of the routing flag, thereby changing over the transmission path. In other words, the routing-tag assembler/disassembler 208e′ on the protection side adds a routing flag, which is the same as that of the routing-tag assembler/disassembler 208e on the working side, onto a received extended ATM cell. As a result, the SONET ADM unit A (201) drops the extended ATM cell from the SONET ADM unit C (203) from the optical fiber of the protection channel.

Thus, in accordance with this embodiment, a service using extended ATM cells can be implemented in addition to the conventional services and a protection switch for supporting extended ATM cells can be realized.

Though the foregoing has been described in connection with ATM cells, the present invention is not limited to ATM cells.

In accordance with the present invention, extended-cells in which fixed-length cells and variable-length cells are mixed can be subjected to processing equivalent to that of fixed-length cells in the prior art, thereby making communication of extended-cells possible.

Further, in accordance with the present invention, a disadvantage of conventional fixed-length ATM cells, namely the fact that IP packets cannot be transmitted efficiently, can be overcome. Moreover, the rich QoS function, congestion control and bandwidth assurance functions and versatile, efficient network architecture originally associated with ATM can be implemented in the communication of IP packets and the like.

Further, in accordance with the present invention, the system is essentially connectionless. This makes it possible to overcome the disadvantage of an IP network, namely the fact that adequate QoS cannot be assured.

Further, in accordance with the present invention, the original merits of ATM can be obtained even in the communication of packets of large frame length. As a result, real-time voice communication and transmission of still and moving images, which have posed problems in IP networks in the prior art, can be realized.

Further, in accordance with the present invention, already existing ATM networks, IP networks, SONET/SDH networks and photonic (DWDM, OADM) networks can readily be connected to an extended ATM network, thereby enabling system expansion.

Further, in accordance with the present invention, data of a high-speed terminal or extended ATM cell apparatus can be transmitted at high speed via an SDH transmission apparatus that accommodates VC-4 in the payload of an STM-1 frame. This makes it possible to enhance the performance of an SDH transmission apparatus of this kind.

Further, in accordance with the present invention, the communication of extended-cells can be continued by bypass in the event of a failure. Moreover, since the VPI of a bypass virtual path used in performing bypass can be used jointly in failures of a plurality of types, no limitation is imposed on the number of VPIs that can be applied to a working virtual path.

Further, in accordance with the present invention, a VPI conversion table is changed over as soon as passage of an OAM cell specifying changeover of the VPI conversion table is detected. As a result, a virtual path can be changed over at high speed when a failure occurs.

Further, in accordance with the present invention, the route status of a bypass virtual path can be monitored at all times, thereby making it possible to provide for changeover of a virtual path when a failure occurs.

Further, in accordance with the present invention, a service using extended-cells such as extended ATM cells can be implemented in addition to the conventional services and a protection switch for supporting extended-cells can be realized.

As many apparently widely different embodiments of the present invention can be made without departing from the spirit and scope thereof, it is to be understood that the invention is not limited to the specific embodiments thereof except as defined in the appended claims.

What is claimed is:

1. A transmission apparatus for applying predetermined processing to and then transmitting extended-cells, comprising:
a receiver for receiving a frame signal from a transmission path;
a demultiplexing/demapping unit for demultiplexing and demapping extended-cells from a payload of the frame signal received from the transmission path;
a cell synchronizer for executing cell synchronization processing to identify an extended-cell boundary;
a controller for subjecting an extended-cell to switching and other control;
a multiplexing/mapping unit for multiplexing and mapping an extended-cell, which is output from said controller, onto a payload of a frame signal; and
a transmitter for transmitting this frame signal to a transmission path.

2. The apparatus according to claim 1, wherein the extended-cell is a variable-length ATM cell, cell length of which is fixed at a cell length that is optimum for storing an IP packet in a payload of the variable-length ATM cell, and processing is limited to two types, namely processing of fixed-length ATM cells and processing of the variable-length ATM cells.

3. A communication network, comprising:
an extended-cell communication network for transmitting extended-cells in which fixed-length and variable-length cells are mixed or extended-cells in which the formats of fixed-length cells and variable-length cells are unified;
a fixed-length-cell communication network for transmitting fixed-length cells; and
a conversion unit for connecting between the extended cell communication network and the fixed-length-cell communication network, allowing fixed-length cells to pass through both networks and converting variable-length cells to fixed-length cells and sending the fixed-length cells to the fixed-length-cell communication network, or a conversion unit for converting between extended-cells and fixed-length cells and sending the resulting cells to a prescribed network.

4. An SDH transmission apparatus for sending and receiving a virtual container, which is obtained by gathering data from a low-speed side, upon mapping the virtual container onto a payload of a transmit-frame signal, comprising:
SOH terminating equipment for inserting/separating a section overhead of a transmit-frame signal and performing a conversion between a virtual container and the transmit-frame signal;
POH terminating equipment for inserting/separating a path overhead POH of a virtual container and implementing synchronous operation of the virtual container by stuff processing of the virtual container;
a high-speed terminal interface or extended ATM interface for interfacing a high-speed terminal or extended ATM apparatus; and
a selector for selecting data from the low-speed side and data from the high-speed terminal or extended ATM apparatus and inputting the selected data to the POH terminating equipment.

5. A transmission apparatus of an extended-cell communication network for performing communication between a first transmission apparatus (node) and a second node via a working route using extended-cells and performing communication via a bypass route when a failure occurs, comprising:
a first VPI conversion table for converting a VPI of an extended-cell, which enters when communication is normal, to a VPI for a working virtual path;
a second VPI conversion table for converting a VPI of an extended-cell, which enters when the network develops a failure, to a VPI for a bypass virtual path;
a conversion table creation unit for creating said first and second VPI conversion tables;
conversion table distribution means for reorganizing said first and second VPI conversion tables node by node and distributing the reorganized first and second VPI conversion tables to each of the nodes; and
means for setting up one bypass-route monitoring control virtual path for each bypass route and sending a monitor cell to each bypass route via the bypass-route monitoring control virtual paths.

6. The apparatus according to claim 5, wherein said first and second nodes are connected by a working route and a plurality of bypass routes each of which includes intermediate nodes;
a link forming a route that connects each of the nodes accommodates a plurality of virtual paths; and
each virtual path is classified into a working virtual path, a bypass-route monitoring control virtual path and a bypass virtual path.

7. The apparatus according to claim 6, wherein said first VPI conversion table includes a VPI conversion table for converting a VPI, which has entered via the bypass-route monitoring control virtual path, to a VPI for the bypass-route monitoring control virtual path.

8. An extended-cell communication network for performing communication between a first transmission apparatus (node) and a second node via a working route using extended-cells in which fixed-length and variable-length cells are mixed and performing communication via a bypass route when a failure occurs, wherein:
each node has a first VPI conversion table for converting a VPI of an extended-cell, which enters when communication is normal, to a VPI for a working virtual path; a second VPI conversion table for converting a VPI of an extended-cell, which enters when the network develops a failure, to a VPI for a bypass virtual path; and means for setting up one bypass-route monitoring control virtual path for each bypass route and sending a monitor cell to each bypass route via the bypass-route monitoring control virtual paths;
said first and second nodes are connected by a working route and a plurality of bypass routes each of which includes intermediate nodes;
if a failure occurs in the working route, said second node detects the failure and sends an alarm to said first node;
said first node, which has received the alarm, sends each of the bypass-route monitoring control virtual paths a changeover command cell for instructing each intermediate node to change over a conversion table from said first VPI conversion table to said second VPI conversion table; and
said first node and said intermediate nodes, the latter of which have received the changeover command, change over a conversion table used from said first VPI conversion table to said second VPI conversion table, convert a VPI of an entered extended ATM cell in accordance with said second VPI conversion table and transmit this extended ATM cell to said second node via a bypass virtual path of said bypass route.

9. The network according to claim 8, wherein a link connecting each of the nodes accommodates a plurality of virtual paths each of which is classified into a working virtual path, a bypass-route monitoring control virtual path and a bypass virtual path;
when a node has detected the changeover command cell from a plurality of bypass-route monitoring control virtual paths accommodated in a link constructing said bypass route, said node reports simultaneous failure to all nodes downstream of said node and to an operating system; and
upon being notified of the simultaneous failure, the operating system arbitrates contention involving simultaneous failure and re-establishes a bypass route.

10. The network according to claim 9, wherein if the working route recovers from failure, a VPI conversion table restore command transmitted from the operating system is received by a prescribed node, said node transmits the changeover command cell to said bypass-route monitoring control virtual path based upon the restore command, and said intermediate nodes change over the conversion table used from said second VPI conversion table to said first VPI conversion table in response to receipt of the changeover command cell.

11. The network according to claim 8, wherein if one of said intermediate nodes detects an abnormality in a bypass route that includes this intermediate node at the time of normal communication, all downstream nodes and the operating system are notified of the abnormality.

12. The network according to claim 8, wherein said second node transmits a bypass-route monitor cell periodically and said first node transmits the VPI conversion table changeover command cell periodically when a failure occurs.

13. An add/drop multiplexing apparatus for extracting a signal of a low-order communication network from a signal received from a high-order transmission path, inserting a signal that enters from the low-order communication network and sending the signal to the high-order transmission path, comprising:
a receiver for receiving a frame signal from the high-order transmission path;
a cross-connect unit for cross connecting a signal, which has been mapped onto a payload of the frame signal received by said receiver, and extracting a prescribed signal having a first format;
a tributary interface for converting the signal, which has been extracted by said cross-connect unit, to a signal having a second format that corresponds to the low-order communication network; and
a transmitter for mapping a signal, which has been cross connected by said cross-connect unit, onto a payload of a frame signal and sending this frame signal to the high-order transmission path;
wherein said tributary interface converts an extended-cell, which has been received from the low-order communication network, to a signal having the first format capable of being processed by said cross-connect unit, converts a signal, which has been output from said cross-connect unit, to an extended-cell as said signal having the second format and sends the extended-cell to the low-order communication network.

14. The apparatus according to claim 13, wherein said tributary interface includes:
a VC table in which an identifier of a virtual channel being used by the low-order communication network is registered;
signal terminating equipment for converting a signal, which has been output from said cross-connect unit, to an extended-cell;
a routing-tag assembling unit for extracting a virtual-channel identifier from a header of the extended-cell output from said signal terminating equipment, comparing the extracted virtual-channel identifier and the virtual-channel identifier that has been registered in said VC table, and if the two virtual-channel identifiers match, adding a routing tag, which indicates that the low-order communication network is the destination, onto the extended-cell; and
a routing device for referring to a routing tag of an extended-cell that has been output from said routing-tag assembling unit, determining whether the destination of this extended-cell is the low-order communication network, transferring this extended-cell to the low-order communication network if the destination of the extended-cell is the low-order communication network, and sending this extended-cell back to the routing-tag assembling unit if the destination of the extended-cell is not the low-order communication network; and
a routing-tag disassembling unit for removing a routing tag from an extended-cell that is transmitted from said routing device to the low-order communication network.

15. The apparatus according to claim 14, wherein when an extended-cell is sent back from said routing device, said routing tag assembling unit removes a routing tag from this extended-cell and sends the extended-cell from which the routing tag has been removed back to said cross-connect unit.

16. The apparatus according to claim 14, wherein in a case where a communication network is constructed by connecting a plurality of add/drop multiplexing apparatus in ring form by a working transmission path and a protection transmission path, said tributary interface has first and second signal terminating equipments for the working and protection transmission paths as said signal terminating equipment, and first and second routing-tag assembling units for the working and protection transmission paths as said routing-tag assembling unit;
when an extended-cell, which indicates that the low-order communication network is the destination, has entered from said first signal terminating equipment of the working transmission path, said first routing-tag assembling unit for the working transmission path adds a routing tag, which indicates that the low-order communication network is the destination, onto the extended-cell;
when an extended-cell, which indicates that the low-order communication network is the destination, has entered from said second signal terminating equipment of the protection transmission path, said second routing-tag assembling unit for the protection transmission path adds a routing tag, which indicates that this extended-cell is to be discarded, onto the extended-cell; and
said routing device transfers an extended ATM cell, which has entered from said first routing-tag assembling unit of the working transmission path, to the low-order communication network and discards an extended ATM cell that has entered from said second routing-tag assembling unit of the protection transmission path.

17. The apparatus according to claim 16, wherein said tributary interface has a ring topology map for holding topology information indicating the topology of add/drop multiplexing apparatus that construct the ring-shaped communication network.

18. The apparatus according to claim 17, wherein said tributary interface has a switch map for holding, in association with apparatus identification information identifying each add/drop multiplexing apparatus that constructs the ring-shaped communication network, transmission-path changeover information indicating whether it is necessary to switch between working and protection channels when a failure occurs in an add/drop multiplexing apparatus.

19. The apparatus according to claim 16, wherein said tributary interface has:
a ring topology map for holding topology information indicating the topology of add/drop multiplexing apparatus that construct the ring-shaped communication network;
a switch map for holding, in association with apparatus identification information identifying each add/drop multiplexing apparatus that constructs the ring-shaped communication network, transmission-path changeover information indicating whether it is necessary to switch between working and protection channels when a failure occurs in an add/drop multiplexing apparatus;
a failure detector for judging that a failure has occurred in a neighboring upstream add/drop multiplexing apparatus by referring to said ring topology map when non-synchronization of a received extended-cell is detected;
a failure-occurrence notification unit for transmitting an OAM cell, in which has been recorded apparatus identification information specifying an upstream add/drop multiplexing apparatus, over said communication network when a failure has been detected by said failure detector; and
a transmission-path changeover unit which, when an OAM cell transmitted from another add/drop multiplexing apparatus has been received, is for extracting apparatus identification information from this OAM cell, searching said switch map based upon this apparatus identification information and, if a result of the search indicates that it is necessary to switch between the working and protection channels, interchanging content of the routing tag assembled by said first routing-tag assembling unit for the working transmission path and content of the routing tag assembled by said second routing-tag assembling unit for the protection transmission path.
